(19) United States
(12) Patent Application Publication
(10) Pub. No.: US 2026/0275679 A1
(43) Pub. Date: Sep. 17, 2026

(54) CONTROL DEVICE, CONTROL METHOD, AND WORK MACHINE

(71) Applicant: KOMATSU LTD., Tokyo (JP)

(72) Inventors: Tomoki Konda, Tokyo (JP); Kazuhiro Hatake, Tokyo (JP); Takahiro Hirama, Tokyo (JP); Yosuke Uchida, Tokyo (JP)

(73) Assignee: KOMATSU LTD., Tokyo (JP)

(21) Appl. No.: 19/469,531

(22) PCT Filed: Mar. 27, 2024
(86) PCT No.: PCT/JP2024/012390

§ 371 Date: Sep. 26, 2025

(30) Foreign Application Priority Data
Mar. 31, 2023 (JP) 2023-056912

(51) Int. Cl. E02F 3/43; E02F 3/32; E02F 9/12; E02F 9/20; E02F 9/26

(52) U.S. Cl. CPC E02F 3/439; E02F 9/123; E02F 9/2033; E02F 9/262; E02F 3/32

(57) ABSTRACT

A control device provides a control device of a work machine including a revolving body configured to revolve around a revolution center, and a work implement including a work tool and attached to the revolving body, the control device including an operation instruction signal generating unit configured to perform control of moving the work tool to a target position, and a reference point setting unit configured to set a reference point, in which the operation instruction signal generating unit performs the control on the basis of the reference point.

### TECHNICAL FIELD

The present disclosure relates to a control device, a control method, and a work machine. The present application claims priority based on JP 2023-056912, filed in Japan on Mar. 31, 2023, the content of which is incorporated herein by reference.

### BACKGROUND ART

Patent Document 1 describes a control device for a loading machine including a revolving body and a work implement, and the control device is able to automate movement of the work implement between a loading position and an excavation position.

### CITATION LIST

### Patent Literature

Patent Document 1: JP 2020-41352 A

### SUMMARY OF INVENTION

### Technical Problem

The technique described in Patent Document 1 is configured to set an interference avoiding point used to prevent interference between a loading target and a bucket, and perform control of automatically moving to an excavation position via the interference avoiding point. However, when the position changes due to a loading operation, a useless operation may occur, such as taking a long way to move to the excavation position via the interference avoiding point.

An object of the present disclosure is to provide a control device, a control method, and a work machine that make it possible to prevent interference between a loading target and a bucket and also suppress a useless operation of a work implement.

### Solution to Problem

One aspect of the present disclosure provides a control device of a work machine including a revolving body configured to revolve around a revolution center, and a work implement including a work tool and attached to the revolving body, the control device including: an operation instruction signal generating unit configured to perform control of moving the work tool to a target position; and a reference point setting unit configured to set a reference point, in which the operation instruction signal generating unit performs the control on the basis of the reference point.

One aspect of the present disclosure provides a control method for a work machine including a revolving body configured to revolve around a revolution center, and a work implement including a work tool and attached to the revolving body, the control method including: setting a reference point; and performing control of moving the work tool to a target position on the basis of the reference point.

One aspect of the present disclosure provides a work machine including a revolving body configured to revolve around a revolution center, a work implement including a work tool and attached to the revolving body, and a control device configured to control the revolving body and the work implement, in which the control device includes, an operation instruction signal generating unit configured to perform control of moving the work tool to a target position, and a reference point setting unit configured to set a reference point, and the operation instruction signal generating unit performs the control on the basis of the reference point.

### Advantageous Effects of Invention

The control device, the control method, and the work machine according to the present disclosure make it possible to prevent interference between a loading target and a bucket and also suppress a useless operation of a work implement.

### BRIEF DESCRIPTION OF DRAWINGS

FIG. 1 is a schematic view illustrating the configuration of a work machine according to an embodiment of the present disclosure.

FIG. 2 is a diagram illustrating the configuration of the inside of a cab according to the embodiment of the present disclosure.

FIG. 3 is a block diagram showing an example of the configuration of a control system according to the embodiment of the present disclosure.

FIG. 4 is a schematic view used to explain an operation example of a control device according to the embodiment of the present disclosure.

FIG. 5 is a schematic view used to explain an operation example of the control device according to the embodiment of the present disclosure.

FIG. 6 is a schematic view used to explain an operation example of the control device according to the embodiment of the present disclosure.

FIG. 7 is a schematic view used to explain an operation example of the control device according to the embodiment of the present disclosure.

FIG. 8 is a schematic view used to explain an operation example of the control device according to the embodiment of the present disclosure.

FIG. 9 is a schematic view used to explain an operation example of the control device according to the embodiment of the present disclosure.

FIG. 10 is a schematic view used to explain an operation example of the control device according to the embodiment of the present disclosure.

FIG. 11 is a schematic view used to explain an operation example of the control device according to the embodiment of the present disclosure.

FIG. 12 is a flowchart showing an operation example of the control device according to the embodiment of the present disclosure.

FIG. 13 is a schematic view used to explain an operation example of the control device according to the embodiment of the present disclosure.

FIG. 14 is a schematic view used to explain an operation example of the control device according to the embodiment of the present disclosure.

FIG. 15 is a flowchart showing an operation example of the control device according to the embodiment of the present disclosure.

FIG. 16 is a schematic view used to explain an operation example of the control device according to the embodiment of the present disclosure.

FIG. 17 is a schematic view used to explain an operation example of the control device according to the embodiment of the present disclosure.

FIG. 18 is a schematic view used to explain an operation example of the control device according to the embodiment of the present disclosure.

FIG. 19 is a schematic view used to explain an operation example of the control device according to the embodiment of the present disclosure.

FIG. 20 is a schematic view used to explain an operation example of the control device according to the embodiment of the present disclosure.

FIG. 21 is a flowchart showing an operation example of the control device according to the embodiment of the present disclosure.

FIG. 22 is a schematic view used to explain an operation example of the control device according to the embodiment of the present disclosure.

FIG. 23 is a flowchart showing an operation example of the control device according to the embodiment of the present disclosure.

FIG. 24 is a schematic view used to explain an operation example of the control device according to the embodiment of the present disclosure.

FIG. 25 is a flowchart showing an operation example of the control device according to the embodiment of the present disclosure.

FIG. 26 is a schematic view used to explain an operation example of the control device according to the embodiment of the present disclosure.

FIG. 27 is a flowchart showing an operation example of the control device according to the embodiment of the present disclosure.

FIG. 28 is a flowchart showing an operation example of the control device according to the embodiment of the present disclosure.

FIG. 29 is a flowchart showing an operation example of the control device according to the embodiment of the present disclosure.

FIG. 30 is a flowchart showing an operation example of the control device according to the embodiment of the present disclosure.

### DESCRIPTION OF EMBODIMENTS

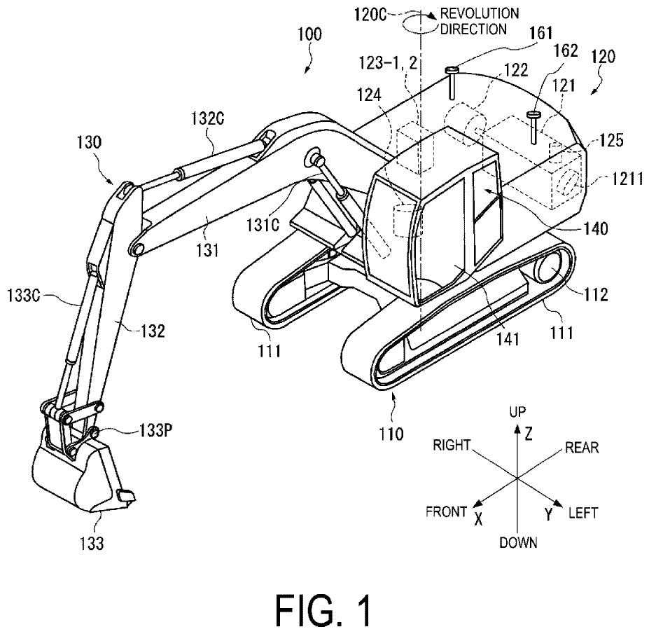

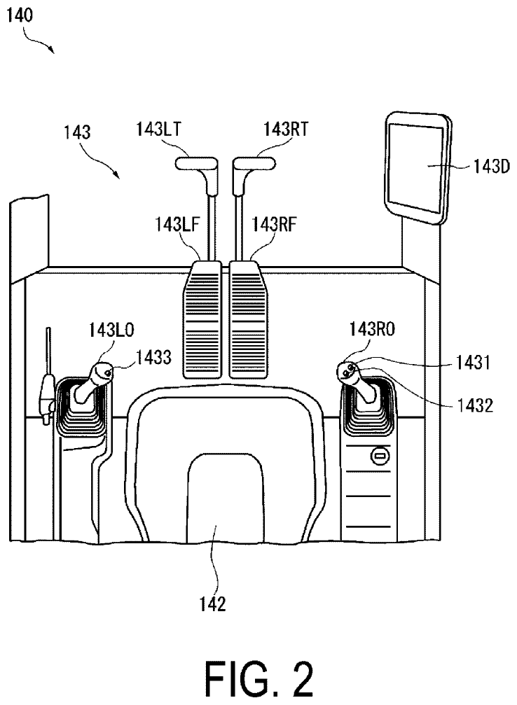

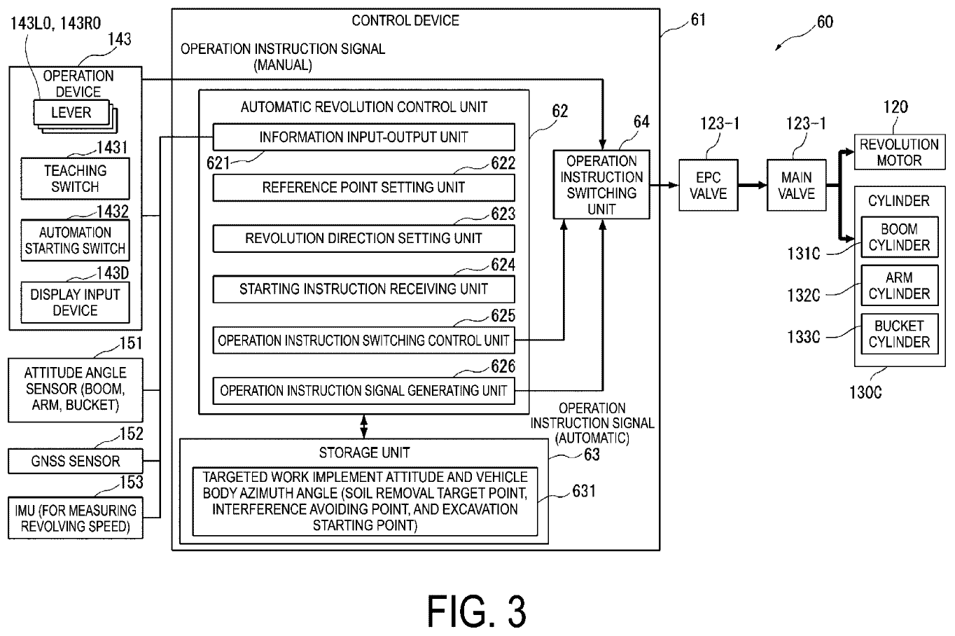

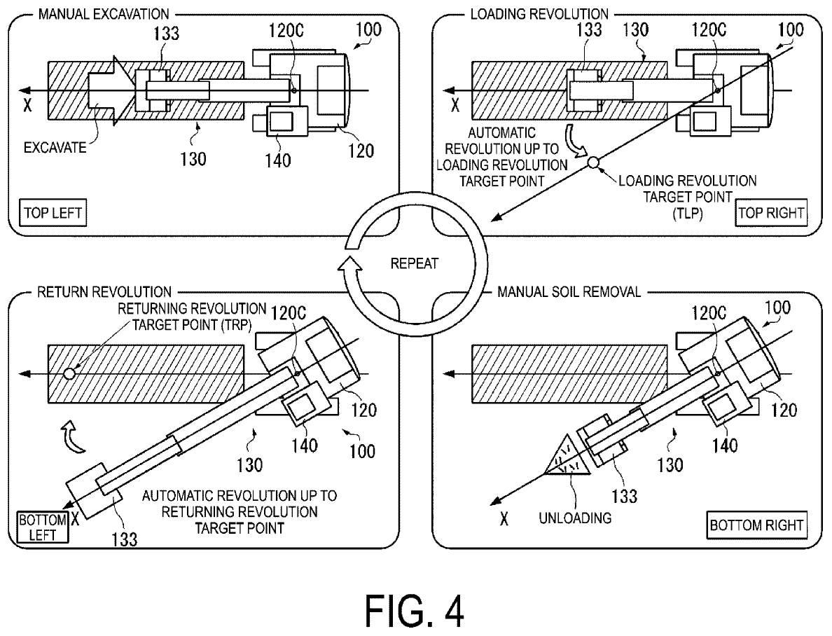

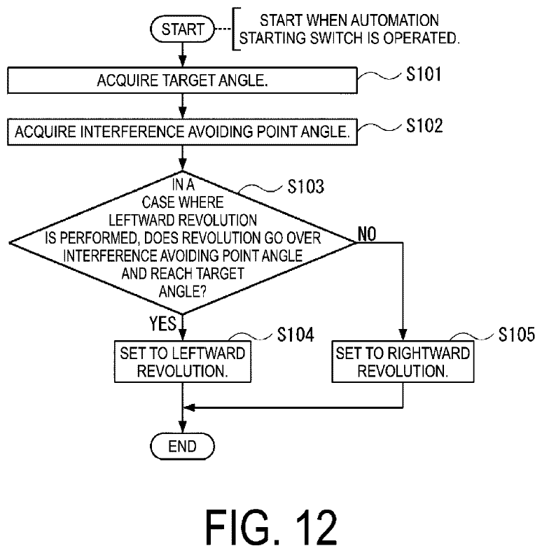

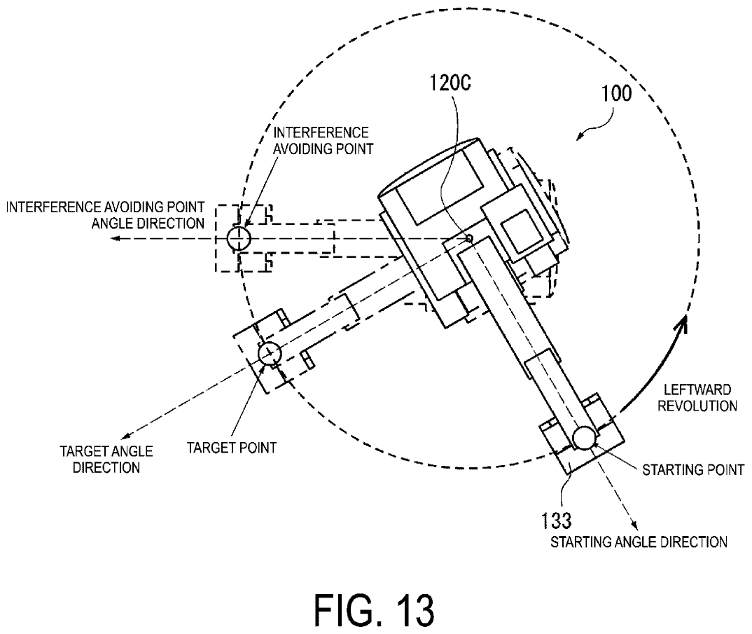

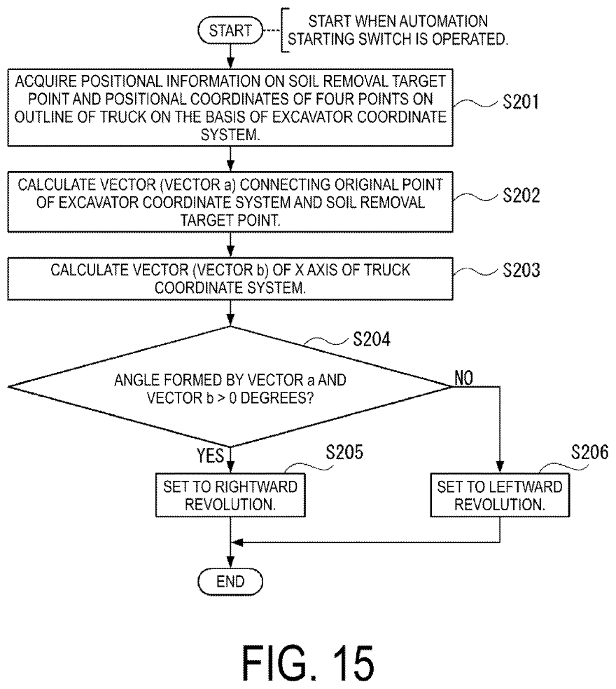

Hereinafter, with reference to the drawings, embodiments of the present disclosure are described. Note that the same or corresponding configurations in the respective drawings are denoted with the same reference symbols, and the description thereof is omitted as appropriate. FIG. 1 is a schematic view illustrating the configuration of a work machine according to an embodiment of the present disclosure. FIG. 2 is a diagram illustrating the configuration of the inside of a cab according to the embodiment of the present disclosure. FIG. 3 is a block diagram showing an example of the configuration of a control system according to the embodiment of the present disclosure. FIGS. 4 to 11 are schematic views each used to explain an operation example of a control device according to the embodiment of the present disclosure. FIG. 12 is a flowchart showing an operation example of the control device according to the embodiment of the present disclosure. FIGS. 15, 21, 23, 25, and 27 to 30 are flowcharts each showing an operation example of the control device according to the embodiment of the present disclosure. FIGS. 13, 14, 16 to 20, 22, 24, and 26 are schematic views each used to explain an operation example of the control device according to the embodiment of the present disclosure.

### Configuration of Work Machine 100

FIG. 1 illustrates the configuration of a work machine 100 according to the embodiment of the present disclosure. The work machine 100 operates at a working site, and works for a work target such as earth or sand. The work machine 100 according to the embodiment of the present disclosure is, for example, a hydraulic excavator. However, there is no limitation as to the work machine according to the present disclosure as long as it is a work machine including a revolving body and a work implement, and may be other work machines such as a face excavator or a rope excavator, for example. The work machine 100 includes a traveling body 110, a revolving body 120, a work implement 130, and a cab 140.

The traveling body 110 supports the work machine 100 so that the work machine 100 can travel. The traveling body 110 includes two crawlers 111 provided at the left and right, and two travel motors 112 used to drive the individual crawlers 111. The revolving body 120 is supported by the traveling body 110 so as to be rotatable about a revolution center.

The work implement 130 is driven by hydraulic pressure. The work implement 130 is supported at a front portion of the revolving body 120 so as to be drivable in an up-down direction. The cab 140 is a space where an operator rides and operates the work machine 100.

The cab 140 is provided in a left front portion of the revolving body 120. Note that, in the present embodiment, the up-down direction (Z direction), the left-right direction (Y direction), and the front-rear direction (X direction) are set with the revolving body 120 being the reference, as illustrated in FIG. 1. In the present embodiment, this coordinate system is referred to as an excavator coordinate system. In addition, a portion of the revolving body 120 where the work implement 130 is attached is referred to as a front portion. Further, in the revolving body 120, with reference to the front portion, a portion on a side opposite thereto is referred to as a rear portion, a portion on the left side is referred to as a left portion, and a portion on the right side is referred to as a right portion.

### Configuration of Revolving Body 120

The revolving body 120 includes an engine 121, a hydraulic pump 122, an electromagnetic proportional control (EPC) valve 123-1, a main valve 123-2, a revolution motor 124, and a fuel injection device 125. The engine 121 is a prime mover that drives the hydraulic pump 122. The engine 121 is an example of a power source. A self-starting motor 1211 is provided at the engine 121. The engine 121 is started by the rotation of the self-starting motor 1211. The EPC valve 123-1 controls hydraulic oil flowing through the main valve 123-2 on the basis of an operation instruction signal outputted by a control device 61.

The hydraulic pump 122 is a variable displacement pump driven by the engine 121. The hydraulic pump 122 supplies each actuator with hydraulic oil through the main valve 123-2.

Each actuator includes a boom cylinder 131C, an arm cylinder 132C, a bucket cylinder 133C, a travel motor 112, and a revolution motor 124. The main valve 123-2 is configured to control the flow rate of hydraulic oil supplied from the hydraulic pump 122.

The revolution motor 124 drives with hydraulic oil supplied from the hydraulic pump 122 through the main valve 123-2 to cause the revolving body 120 to revolve around a revolution axis 120C (revolution center). The fuel injection device 125 injects the fuel into the engine 121.

Configuration of Work Implement 130

The work implement 130 includes a boom 131, an arm 132, a bucket 133 serving as a work tool, a boom cylinder 131C, an arm cylinder 132C, and a bucket cylinder 133C. Note that the boom cylinder 131C, the arm cylinder 132C, and the bucket cylinder 133C are included in a cylinder 130C illustrated in FIG. 3. Note that, in addition to a bucket, the work tool that is an attachment includes a slope bucket, a tilt rotator, a quick coupler, a grapple, a magnet, and a breaker, or the like.

A base end portion of the boom 131 is attached to the revolving body 120 through a boom pin. The arm 132 couples the boom 131 and the bucket 133. A base end portion of the arm 132 is attached to the distal end portion of the boom 131 through an arm pin. The bucket 133 includes a blade for excavating earth and sand or the like, and an accommodation portion for holds the excavated earth and sand. A base end portion of the bucket 133 is attached to the distal end portion of the arm 132 through a bucket pin 133P.

The boom cylinder 131C is a hydraulic cylinder for actuating the boom 131. A base end portion of the boom cylinder 131C is attached to the revolving body 120. A distal end portion of the boom cylinder 131C is attached to the boom 131. The arm cylinder 132C is a hydraulic cylinder for driving the arm 132. A base end portion of the arm cylinder 132C is attached to the boom 131. A distal end portion of the arm cylinder 132C is attached to the arm 132. The bucket cylinder 133C is a hydraulic cylinder for driving the bucket 133. A base end portion of the bucket cylinder 133C is attached to the arm 132. The distal end portion of the bucket cylinder 133C is attached to a link member coupled to the bucket 133.

### Configuration of Cab 140

FIG. 2 illustrates the configuration of the inside of the cab 140 according to the embodiment of the present disclosure. An operator seat 142, an operation device 143, and the like are provided in the cab 140.

The operation device 143 is a device used to drive the traveling body 110, the revolving body 120, and the work implement 130 through a manual operation by an operator, set various types of setting values, change these values, or provide the operator with information. The operation device 143 includes a lever, a switch, and a pedal, for example. The operation device 143 includes a left operation lever 143LO, a right operation lever 143RO, a left foot pedal 143LF, a right foot pedal 143RF, a left travel lever 143LT, a right travel lever 143RT, and a display input device 143D. The switch includes various types of switches such as a push button switch, a rocker switch, or a toggle switch, for example. In addition, it is only necessary that the switch is provided within a range in which the operator can operate. The switch is provided at or around an operator seat provided in the cab 140, in a remote operation room, or the like. For example, it may be provided in a console at the side of the operator seat 142, a transmitter that outputs an operation instruction to the work machine 100 from the outside of the work machine 100, or the like.

The left operation lever 143LO is provided at the left side of the operator seat 142. The right operation lever 143RO is provided at the right side of the operator seat 142.

The left operation lever 143LO is an operation mechanism for performing an operation of revolving the revolving body 120 and an operation of excavation/dumping by the arm 132. Specifically, when an operator of the work machine 100 tilts the left operation lever 143LO in a forward direction, the arm 132 performs the dumping operation. In addition, when the operator of the work machine 100 tilts the left operation lever 143LO in a rearward direction, the arm 132 performs the excavation operation. Furthermore, when the operator of the work machine 100 tilts the left operation lever 143LO in a rightward direction, the revolving body 120 revolves to the right. In addition, when the operator of the work machine 100 tilts the left operation lever 143LO in a leftward direction, the revolving body 120 revolves to the left. Note that, in another embodiment, it may be possible to employ a configuration in which, when the left operation lever 143LO is tilted in the front-rear direction, the revolving body 120 revolves to the right or to the left, and when the left operation lever 143LO is tilted in the left-right direction, the arm 132 performs the excavation operation or the dumping operation. An operation switch 1433 is provided at the left operation lever 143LO. Note that it is only necessary that the operation switch 1433 is provided at a position close to an operator who sits on the operator seat 142. Note that the operation switch 1433 is provided at the upper portion of or a side portion of an operation lever.

The right operation lever 143RO is an operation mechanism for performing the excavation/dumping operation of the bucket 133 and a lifting/lowering operation of the boom 131. Specifically, when the operator of the work machine 100 tilts the right operation lever 143RO in the forward direction, the lowering operation of the boom 131 is performed. In addition, when the operator of the work machine 100 tilts the right operation lever 143RO in the rearward direction, the lifting operation of the boom 131 is performed. Furthermore, when the operator of the work machine 100 tilts the right operation lever 143RO in the rightward direction, the dumping operation of the bucket 133 is performed. In addition, when the operator of the work machine 100 tilts the right operation lever 143RO in the leftward direction, the excavating operation of the bucket 133 is performed. Note that, in another embodiment, it may be possible to employ a configuration in which, when the right operation lever 143RO is tilted in the front-rear direction, the bucket 133 performs the dumping operation or the excavating operation, and when the right operation lever 143RO is tilted in the left-right direction, the boom 131 performs the lifting operation or the lowering operation. Operation switches 1431 and 1432 are provided at the right operation lever 143RO, for example. In the present embodiment, it is assumed that a function as a teaching switch is set to the operation switch 1431, and a function as an automation starting switch is set to the operation switch 1432 (hereinafter, each of these switches is also referred to as a teaching switch 1431 and an automation starting switch 1432 (or simply each referred to as a “switch”)). The switches 1431 and 1432 are provided at the upper portion of or a side portion of an operation lever. Note that the teaching switch and the automation starting switch each serve as one example of a switch for automatic control. When the switches turn ON, the automation starting switch is configured to output an instruction signal with which an automatic operation starts, for example. In addition, the switch is not limited to a signal concerning start of automation, and is only necessary to be a signal concerning an automatic operation. For example, the switch may be a switch that outputs a signal of stopping automation, for example. Furthermore, for example, the allocation of functions of the switch is not limited to automatic control for loading revolution and returning revolution, and may be performed for automatic control such as automatic soil removal in which a soil removal operation is automatically performed using the bucket 133, or automatic excavation in which an excavating operation is automatically performed. For example, it may be possible to employ a configuration in which autonomous driving of automatic excavation, loading revolution, returning revolution, and automatic soil removal are allocated to two or more switches. In addition, it may be possible to employ a configuration in which a plurality of switches are provided at one operation lever, or a configuration in which, by providing a plurality of operation levers, one or a plurality of switches are provided for each of the operation levers.

The left foot pedal 143LF is disposed on the left side of a floor surface in front of the operator seat 142. The right foot pedal 143RF is disposed on the right side of the floor surface in front of the operator seat 142. The left travel lever 143LT is pivotally supported by the left foot pedal 143LF and is configured so that the tilting of the left travel lever 143LT and a depression of the left foot pedal 143LF are interlocked with each other. The right travel lever 143RT is pivotally supported by the right foot pedal 143RF and is configured so that the tilting of the right travel lever 143RT and a depression of the right foot pedal 143RF are interlocked with each other.

The left foot pedal 143LF and the left travel lever 143LT correspond to rotational driving of a left-side crawler of the traveling body 110. Specifically, when the operator of the work machine 100 tilts the left foot pedal 143LF or the left travel lever 143LT in the forward direction, the left-side crawler rotates in the forward traveling direction. Furthermore, when the operator of the work machine 100 tilts the left foot pedal 143LF or the left travel lever 143LT in the rearward direction, the left-side crawler rotates in the rearward traveling direction.

The right foot pedal 143RF and the right travel lever 143RT correspond to rotational driving of a right-side crawler of the traveling body 110. Specifically, when the operator of the work machine 100 tilts the right foot pedal 143RF or the right travel lever 143RT in the forward direction, the right-side crawler rotates in a forward traveling direction. In addition, when the operator of the work machine 100 tilts the right foot pedal 143RF or the right travel lever 143RT in the rearward direction, the right-side crawler rotates in the rearward traveling direction.

The display input device 143D is a device in which a display device and a sensor configured to sense a touch operation to the display screen are combined together. For example, by using the display input device 143D, an operator is able to set various types of setting values or the like, or change the setting values. For example, the display input device 143D may be configured such that the display device including a displaying unit and an input unit that receives an operation of the operator or the like are separately provided.

### Sensor or the Like

As illustrated in FIG. 3, a control system 60 of the work machine 100 includes the control device 61, the operation device 143, and various types of sensors. Note that, in FIG. 3, the circuits of hydraulic pressure systems are illustrated as thick lines. In the example illustrated in FIG. 3, the control system 60 includes an attitude angle sensor 151, a global navigation satellite system (GNSS) sensor 152, and an inertial measurement unit (IMU) 153.

The attitude angle sensor 151 includes a boom attitude angle sensor, an arm attitude angle sensor, and a bucket attitude angle sensor. The boom attitude angle sensor measures an attitude angle of the boom 131. The arms attitude angle sensor measures an attitude angle of the arm 132. The bucket attitude angle sensor measures an attitude angle of the bucket 133.

The GNSS sensor 152 calculates a position of the revolving body 120 and a direction toward which the revolving body 120 is directed. The GNSS sensor 152 includes two receiving units 161 and 162 configured to receive a position determination signal from an artificial satellite that constitutes the GNSS. The two receiving units 161 and 162 are each disposed at different positions of the revolving body 120. The GNSS sensor 152 detects the position of the representative points (original point of the excavator coordinate system) of the revolving body 120 in the construction-site coordinate system, on the basis of the position determination signals that the receiving units 161 and 162 receive. The GNSS sensor 152 uses each of the position determination signals that the two receiving units 161 and 162 receive to calculate the azimuth angle at which the revolving body 120 is directed, as a relationship of the position where one of the receiving units is disposed, relative to the position where the other one of the receiving units is disposed. The azimuth angle (also referred to as “vehicle body azimuth angle) at which the revolving body 120 is directed is equal to a horizontal component of an extending direction of a straight line extending from the boom 131 of the work implement 130 toward the bucket 133, the extending direction being the front direction (X direction) of the revolving body 120.

The IMU 153 measures the acceleration and the angular velocity of the revolving body 120, and detects the attitude (for example, the roll angle and the pitch angle) of the revolving body 120 on the basis of the result of detection. The IMU 153 is disposed at the lower surface of the revolving body 120, for example.

Note that examples of other sensors of the work machine 100 include a stereo camera, a light detection and ranging (LiDAR) device, a laser scanner, or the like. These sensors are provided such that the direction of detection is directed toward the forward direction of the cab 140 of the work machine 100, for example. These sensors identify three-dimensional positions of a target object in a coordinate system with the position of each of the sensors being the reference. Note that these sensors may be provided at either side of the left side portion and the right side portion or both sides of the work machine so as to be directed toward the side direction of the work machine.

In addition, the work machine 100 includes, for example, a near-field communication device used to perform vehicle-to-vehicle communication with other surrounding vehicles or the like, a movable-body communication device used to connect and communicate with a server at a remote area and the like, and the like.

### Basic Operation of Control Device

First, the basic operation of the control device 61 according to the embodiment of the present disclosure will be described with reference to FIGS. 4 to 11. Note that, in the present embodiment, the “loading revolution” represents a revolving operation of, from a state where the bucket 133 is positioned at the outer side of the loading target due to excavation of the excavation target, revolving up to a direction directed at the loading target while the boom 131 is being automatically lifted, and moving to a soil removal point. In addition, the “returning revolution” represents an operation of, from a state where the bucket 133 is positioned above the loading target due to loading, revolving up to a predetermined direction while the boom 131 is being automatically lowered, and moving to an excavation starting point. The soil removal point represents a point at which the loading revolution is targeted, and is set, for example, to a loading platform of a dump truck, or an inserting port of a soil recycler, a hopper, or the like. The dump truck, the soil recycler, the hopper, or the like each serve as one example of the loading target. However, it is not limited to these, and in a case where the excavated earth and sand or the like are moved on the other grounds, it may be possible to set this movement destination as the soil removal point. In the present disclosure, the soil removal point serves as one example of a first target point (hereinafter, also referred to as a loading revolution target point TLP) corresponding to an unloading target position for a load accommodated in the bucket 133 or the like. Furthermore, the excavation starting point is a point at which an automatic returning operation is targeted after completion of the soil removal, and is set, for example, to a point at which excavation is started. In the present disclosure, the excavation starting point serves as one example of a second target point (hereinafter, also referred to as a returning revolution target point TRP) corresponding to a loading target position for excavating the excavation target using the bucket 133 or the like, for example. Note that, in the present embodiment, the soil removal point (loading revolution target point TLP), the excavation starting point (returning revolution target point TRP), and an interference avoiding point, which will be described later, are each referred to as a reference point when these points are collectively mentioned. In addition, in the present embodiment, a portion of the work machine 100 that corresponds to the reference point is a bucket pin 133P. The control device 61 controls the position of the bucket pin 133P with the position or the direction of each of the reference points being the target value. Furthermore, the load revolution target point TLP and the returning revolution target point TRP are each collectively referred to as a target point when these points are collectively mentioned.

FIG. 4 schematically illustrates a series of flows of manual excavation, loading revolution, manual soil removal, and returning revolution. For example, after an operator causes the manual excavation to be performed to load a load such as earth and sand in the bucket 133 as illustrated in the diagram at the top left, and the operator operates the automation starting switch 1432, the work machine 100 illustrated in FIG. 4 starts the loading revolution as illustrated in the diagram at the top right, and achieves a combined operation of the work implement 130 and the revolving body 120 up to the loading revolution target point TLP in an automatic manner. Here, as illustrated in the diagram at the bottom right, the operator causes the manual soil removal to be performed to perform soil removal of the earth and sand in the bucket 133. After completion of the soil removal, when the operator presses the automation starting switch 1432, the returning revolution is started as illustrated in the diagram at the bottom left, and a combined operation of the work implement 130 and the revolving body 120 up to the returning revolution target point TRP is achieved in an automatic manner.

Note that, in the example illustrated in FIGS. 2 and 3, one automation starting switch 1432 is provided so as to be common to the loading revolution and the returning revolution. However, the number thereof may be two or more, and a plurality of switches may be provided. For example, two independent automation starting switches may be provided such that the automation starting switch 1432 (hereinafter, also referred to as a loading revolution automation starting switch 1432) illustrated in FIG. 2 is set as an automation starting switch for load revolution, and an automation starting switch 1433 (hereinafter, also referred to as a returning revolution automation starting switch 1433) illustrated in FIG. 2 is set as an automation starting switch for returning revolution. It may be possible that an operator can set the way of providing switches on an as-appropriate basis.

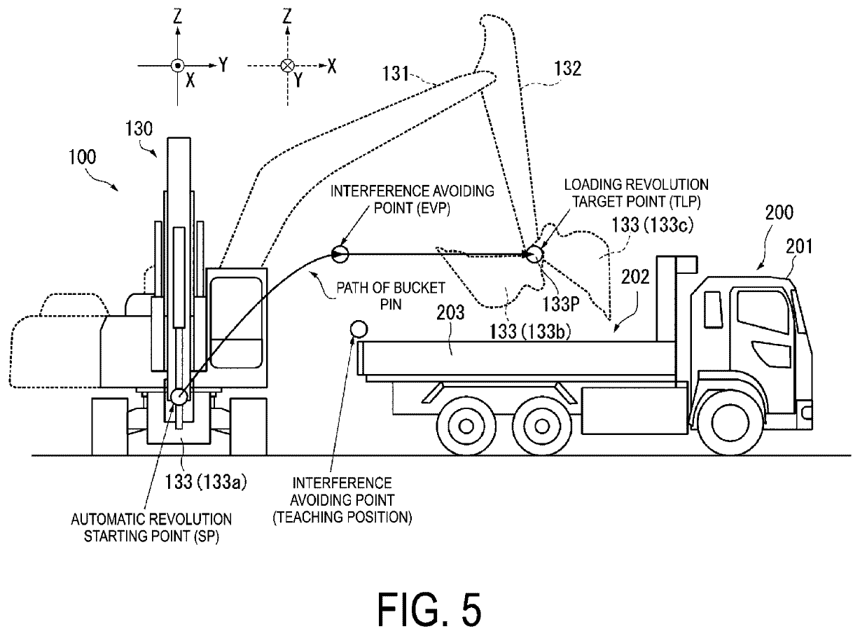

Next, the interference avoiding point will be described with reference to FIG. 5. FIG. 5 schematically illustrates a positional relationship between the work machine 100 and a dump truck 200 serving as a loading target of a load such as earth and sand. The dump truck 200 includes a cab 201, a loading platform 202, and a side plate 203. FIG. 5 illustrates an operation example of the loading revolution. The work machine 100 moves the bucket 133 (133a) positioned at the automatic revolution starting point (SP) due to the operation made to the automation starting switch 1432 through the interference avoiding point (EVP) to the loading target point (TLP). The attitude of the bucket 133 (133b) at the time of reaching the loading revolution target point (TLP) is a holding attitude (in the present embodiment, is an attitude in which a load obtained by excavating the excavation target is accommodated in the bucket 133, and is also referred to as a loading attitude). Here, the operator sets the attitude of the bucket 133 to a dumping attitude (in the present embodiment, is an unloading attitude in which soil removal can be performed for all loads accommodated in the bucket 133, and is also referred to as a soil removal attitude) (bucket 133 (133c)), and performs a soil removal operation. Here, the interference avoiding point (EVP) is a point (positional information) indicating a boundary of areas set so as not to hit against the loading platform 202 of the dump truck 200 or the like. For example, the interference avoiding point (EVP) is a point for setting a position set so as not to hit the loading platform 202 of the dump truck 200 or the like or a direction in which the revolving body 120 is directed. In the present embodiment, only the revolving operation is performed at the soil removal point side (load revolution target point TLP) of this boundary. The interference avoiding point (EVP) can be set on the basis of teaching in which the operator actually operates the work implement to set the direction in which the revolving body 120 is directed and the attitude of the work implement 130, for example. At this time, the interference avoiding point (EVP) is set with a certain margin in the vertical direction and the horizontal direction for the interference avoiding point (teaching position) that the operator registers, as illustrated in FIG. 5, for example. Note that the automatic revolution starting point (SP) is a position of the bucket pin 133P when the loading revolution or the returning revolution starts, and is a position when the operator operates the automation starting switch 1432. In addition, hereinafter, the automatic revolution starting point (SP) is also referred to as a starting point. Note that the automatic revolution starting point (SP) may be a certain specific position of the work implement 130 when the loading revolution or the returning revolution starts, and may be a position of the left-right end of the bucket 133 or a position of the blade edge, for example.

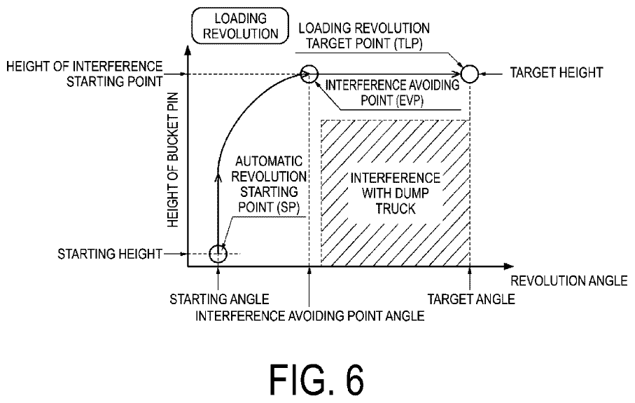

FIG. 6 illustrates an example of a revolution angle and a height position of the bucket pin during the loading revolution. The horizontal axis indicates the revolution angle, and the vertical axis indicates the height of the bucket pin. In FIG. 6, the revolution angle of the automatic revolution starting point (SP) is indicated as the starting angle, the revolution angle of the interference avoiding point (EVP) is indicated as the interference avoiding point angle, and the revolution angle of the loading revolution target point (TLP) is indicated as the target angle. In addition, the height of the automatic revolution starting point (SP) is indicated as the starting height, the height of the interference avoiding point (EVP) is indicated as the height of the interference avoiding point, and the height of the loading revolution target point (TLP) is indicated at the target height. Furthermore, the interference region with the dump truck is shown by hatching. In the example illustrated in FIG. 6, control for the revolving body 120 and lifting control for the boom 131 of the work implement 130 are performed in a combined manner from the automatic revolution starting point (SP) to the interference avoiding point (EVP), whereby the height of the bucket pin reaches the height of an interference starting point before the revolution angle reaches the interference avoiding point angle. In addition, after arrival at the interference avoiding point, the revolution angle reaches the target angle due to alone control for the revolving body 120. In this case, the combined operation of the revolving operation of the revolving body 120 and the lifting operation for the boom 131 of the work implement 130, or an alone operation of the revolving body 120, is controlled on the basis of the interference avoiding point (EVP). In FIG. 6, the starting height of the automatic revolution starting point (SP) in the loading revolution is lower than the target height of the loading revolution target point (TLP). However, for example, the starting height of the automatic revolution starting point (SP) may be higher than at least either the target height of the loading revolution target point (TLP) or the height of the interference avoiding point (EVP). In this case, control for the revolving body 120 and the lowering control for the boom 131 of the work implement 130 are performed in a combined manner from the automatic revolution starting point (SP) to the loading revolution target point (TLP) or the interference avoiding point (EVP).

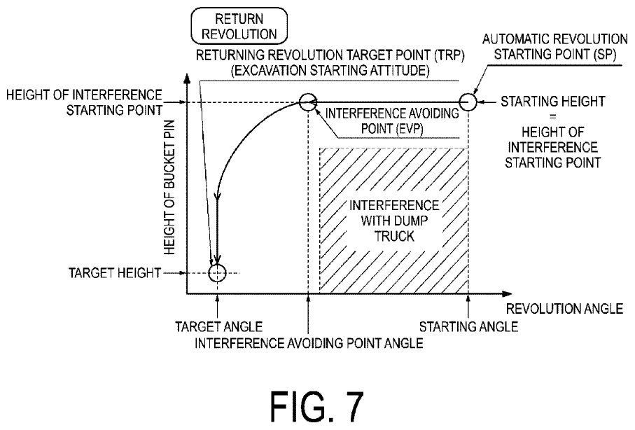

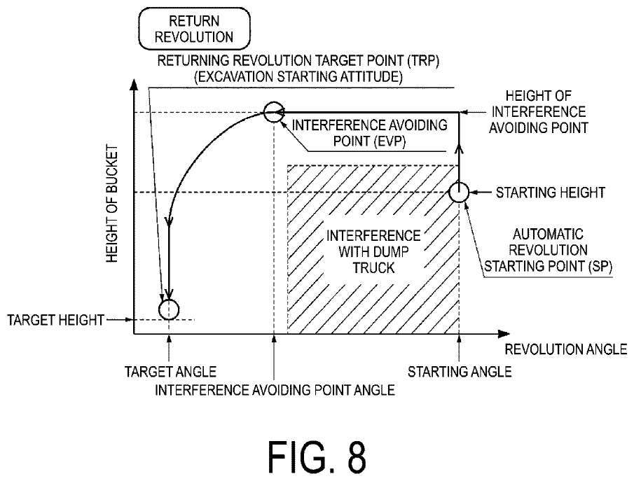

Furthermore, FIGS. 7 and 8 each illustrate an example of the revolution angle in the returning revolution and the height position of the bucket pin. FIG. 7 illustrates an example in a case where the height of the automatic revolution starting point (SP) is equal to the height of the interference avoiding point (EVP). FIG. 8 illustrates an example in a case where the height of the automatic revolution starting point (SP) is lower than the height of the interference avoiding point (EVP). In the example illustrated in FIG. 7, the height of the bucket pin is maintained at the starting height until arrival at the interference avoiding point (EVP), and the revolving body 120 moves due to the alone control for the revolving body 120 from the starting angle to the interference avoiding point angle. Then, after arrival at the interference avoiding point (EVP), revolution control for the revolving body 120 and lower control for the boom 131 of the work implement 130 are performed in a combined manner, whereby the bucket pin reaches the target height and the target angle. In this case, the alone operation of the revolving body 120, or the combined operation of the revolving operation of the revolving body 120 and the lowering operation for the boom 131 of the work implement 130, is controlled on the basis of the interference avoiding point (EVP) of the reference point. Furthermore, in the example illustrated in FIG. 8, the alone control for the work implement 130 by lifting the boom is first performed until the height of the bucket pin reaches the height of the interference avoiding point. After arrival at the height of the interference avoiding point, the height of the bucket pin is maintained at the height of the interference avoiding point until arrival at the interference avoiding point (EVP), the revolution angle moves due to the alone control for the revolving body 120 from the starting angle to the interference avoiding point angle. Then, after arrival at the interference avoiding point (EVP), control for the revolving body 120 and lower control for the boom 131 of the work implement 130 are performed in a combined manner, whereby the height of the bucket pin reaches the target height and the target angle. Note that, in the present embodiment, the returning revolution is controlled such that the attitude of the work implement 130 reaches the target attitude before arrival at the target angle and the target height. In FIGS. 7 and 8, in the returning revolution, the starting height of the automatic revolution starting point (SP) is higher than the target height of the returning revolution target point (TRP). However, for example, at least either the starting height of the automatic revolution starting point (SP) or the height of the interference avoiding point (EVP) may be lower than the target height of the returning revolution target point (TRP). In this case, control for the revolving body 120 and the lifting control for the boom 131 of the work implement 130 are performed in a combined manner from the automatic revolution starting point (SP) to the returning revolution target point (TRP) or the interference avoiding point (EVP).

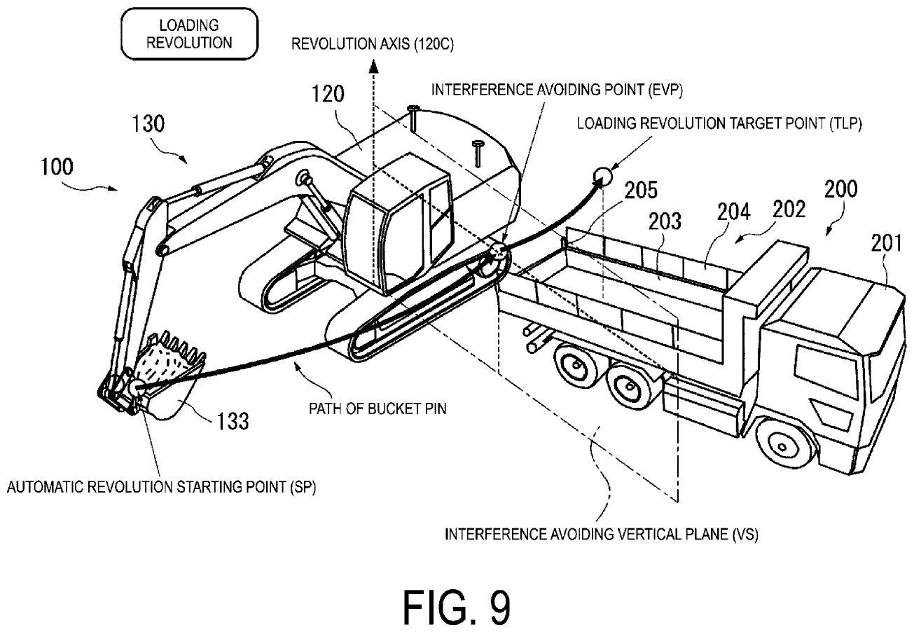

FIG. 9 indicates an example in which an operation example in the loading revolution is illustrated using a perspective view. Note that, in addition to the side plate 203, the dump truck 200 that is a transporting vehicle includes a side guard plate (spreading preventing device) 204, and also includes a hinge 205. The side guard plate 204 or the hinge 205 serves as an example of an interfering object. In the example illustrated in FIG. 9, the path of the bucket pin extends from the automatic revolution starting point (SP) to the interference avoiding point (EVP) due to an operation (hereinafter, referred to as a combined operation) of both the work implement 130 and the revolving body 120, and continues from the interference avoiding point (EVP) to the loading revolution target point (TLP) due to the alone operation of the revolving body 120. That is, in the present embodiment, operations of the revolving body 120 and the work implement 130 are controlled with the reference being the revolution axis 120C of the revolving body 120 and an interference avoiding vertical plane (VS) that is a perpendicular plane including the interference avoiding point (EVP). A region having a boundary at the interference avoiding vertical plane (VS) is set as the first region or the second region. The region from the excavation starting point to the interference avoiding vertical plane (VS) is set as the first region. The region from the interference avoiding vertical plane (VS) to the soil removal point is set as the second region. The combined operation of the work implement 130 and the revolving body 120 is performed in the first region. That is, control of the attitude of the work implement and control of the revolution of the revolving body are combined and are performed on the basis of the first region. For the alone operation of the revolving body 120 in the second region, control of revolution of the revolving body 120 is performed. In this case, the first region ranges from the excavation starting point to the interference avoiding vertical plane (VS), and as for the path of the bucket pin, the combined operation of the work implement 130 and the revolving body 120 is performed from the automatic revolution starting point (SP) up to the interference avoiding point (EVP) set on the basis of the reference point. After passing through the interference avoiding point (EVP), the second region is set to range from the interference avoiding point (EVP) to a load-loading-revolution target point (TLP), and the alone operation of the revolving body 120 is performed.

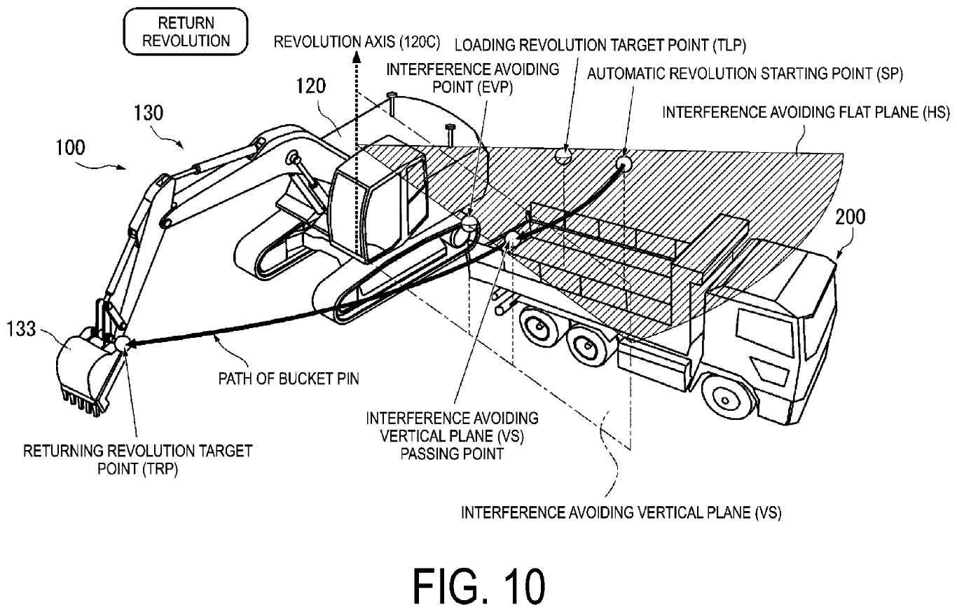

FIG. 10 indicates an example in which an operation example in the returning revolution is illustrated using a perspective view. In the example illustrated in FIG. 10, the height of the automatic revolution starting point (SP) is higher than the height of the interference avoiding point (EVP). In addition, the automatic revolution starting point (SP) and the interference avoiding point (EVP) differ in their positions. In this case, in the present embodiment, avoiding the interference between the bucket 133 and the loading target is achieved with the reference being a perpendicular plane (interference avoiding vertical plane (VS)) including the revolution axis 120C of the revolving body 120 and the interference avoiding point (EVP). Note that, in the present embodiment, the interference avoiding vertical plane (VS) and an interference avoiding flat plane (HS) are collectively referred to as an interference avoiding plane. In this example, the path of the bucket pin extends from the automatic revolution starting point (SP) until passing through the interference avoiding vertical plane (VS) due to the alone operation of the revolving body 120. After passing through the interference avoiding vertical plane (VS), it continues to the returning revolution target point (TRP) due to the combined operation of the work implement 130 and the revolving body 120. That is, in the second region ranging from the soil removal point to the interference avoiding vertical plane (VS), the alone operation of the revolving body 120 is performed from the automatic revolution starting point (SP) to the interference avoiding vertical plane (VS). After passing through the interference avoiding vertical plane (VS), the combined operation of the work implement 130 and the revolving body 120 is performed in the first region ranging from the interference avoiding vertical plane (VS) to the excavation starting point. In this case, in the returning revolution control, in a case where the height of the automatic revolution starting point (SP) is higher than the height of the interference avoiding point (EVP), only the revolving body 120 revolves up to the interference avoiding vertical plane (VS), and does not pass through the interference avoiding point (EVP). That is, no return is performed from the automatic revolution starting point (SP) to the interference avoiding point, and hence, it is possible to control a useless operation of the work implement. In this case, the interference avoiding vertical plane (VS) is passed through in the returning revolution. In addition, an interference avoiding vertical plane (VS) passing point included in the interference avoiding vertical plane (VS) and the interference avoiding point (EVP) that is passed through in the loading revolution differ in their positions.

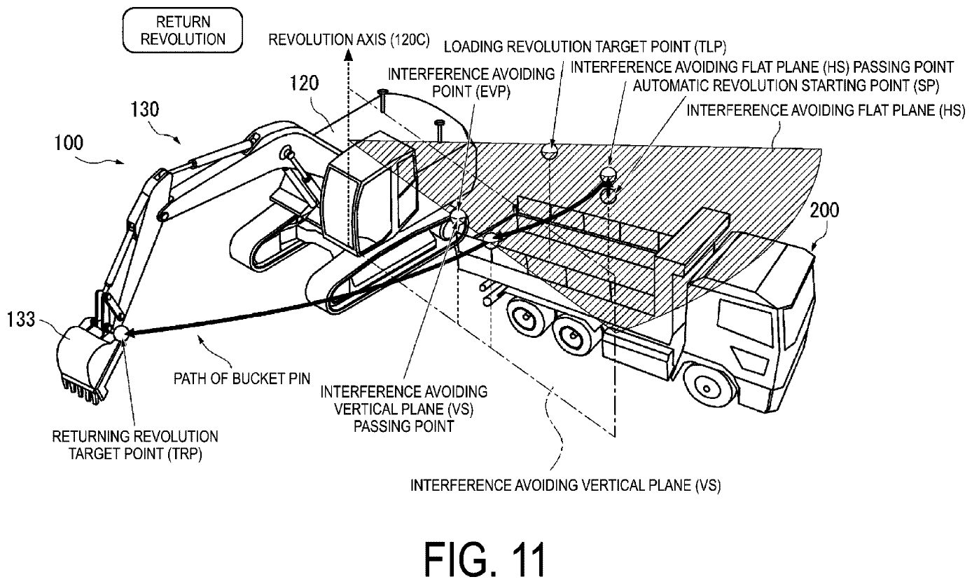

FIG. 11 indicates an example in which an operation example in the returning revolution is illustrated using a perspective view. In the example illustrated in FIG. 11, the height of the automatic revolution starting point (SP) is lower than the height of the interference avoiding point (EVP). In addition, the automatic revolution starting point (SP) and the interference avoiding point (EVP) differ in their positions. In this case, in the present embodiment, the work implement 130 is controlled until the height of the bucket pin 133P is equal to or higher than the height of the interference avoiding flat plane (HS) with the reference being a horizontal flat plane (interference avoiding flat plane (HS)) including the interference avoiding point (EVP). After this, as with the example illustrated in FIG. 10, avoiding the interference between the bucket 133 and the loading target is achieved with the reference being the interference avoiding vertical plane (VS). In this example, the path of the bucket pin extends so as to ascend from the automatic revolution starting point (SP) until reaching the interference avoiding flat plane (HS), then extends due to the alone operation of the revolving body 120 until passing through the interference avoiding vertical plane (VS), and after passing through the interference avoiding vertical plane (VS), continues up to the returning revolution target point (TRP) due to the combined operation of the work implement 130 and the revolving body 120. For example, in the returning revolution control, the combined operation of the lifting operation of the boom 131 of the work implement 130 and the revolving operation of the revolving body 120 may be performed from the automatic revolution starting point (SP) to the interference avoiding vertical plane (VS). In this case, the interference avoiding point is not passed through, and hence, no return is performed from the automatic revolution starting point (SP) to the interference avoiding point. This makes it possible to control a useless operation of the work implement.

### Configuration of Control Device

As illustrated in FIG. 3, the control device 61 can be configured by using, for example, a computer such as a micro-controller, and includes an automatic revolution control unit 62, a storage unit 63, and an operation instruction switching unit 64 as a functional configuration including a combination or the like of hardware such as a computer, peripheral devices of the computer, a peripheral circuit, and software such as a program or the like that this computer executes. In addition, the automatic revolution control unit 62 includes an information input-output unit 621, a reference point setting unit 622, a revolution direction setting unit 623, a starting instruction receiving unit 624, an operation instruction switching control unit 625, and an operation instruction signal generating unit 626. Furthermore, the storage unit 63 holds information 631 or the like indicating the targeted work implement attitude and vehicle body azimuth angle (the soil removal target point, the interference avoiding point, and the excavation starting point).

The automatic revolution control unit 62 generates an operation instruction signal (automatic), and outputs it to the EPC valve 123-1 through the operation instruction switching unit 64 to drive the revolving body 120 and the work implement 130.

The information input-output unit 621 inputs predetermined information outputted by the operation device 143, the attitude angle sensor 151, the GNSS sensor 152, the IMU 153, and the like, and outputs predetermined display information to the display input device 143D.

The reference point setting unit 622 sets the loading revolution target point TLP (soil removal point), the returning revolution target point TRP (excavation starting point), and the interference avoiding point (EVP). In the present embodiment, an operator teaches these reference points, which makes it possible to set them, create a three-dimensional map or the like as described in Patent Document 1, and perform setting on the basis of the created three-dimensional map or the like. The operator can select the setting method on an as-necessary basis, for example. Here, description will be made of an example in which the operator performs teaching to perform setting.

The reference point setting unit 622 causes the display input device 143D to display an instruction to move the bucket 133 to the excavation starting point. The operator operates the operation device 143 to move the bucket 133 to the excavation starting point, and inputs completion of movement to the excavation starting point into the display input device 143D.

Next, the reference point setting unit 622 causes the display input device 143D to display an instruction to move the bucket 133 to the interference avoiding point. The operator operates the operation device 143 to move the bucket 133 to the interference avoiding point, and inputs completion of movement to the interference avoiding point into the display input device 143D.

Next, the reference point setting unit 622 causes the display input device 143D to display an instruction to move the bucket 133 to the soil removal point. The operator operates the operation device 143 to move the bucket 133 to the soil removal point, and inputs completion of movement to the soil removal point into the display input device 143D.

The reference point setting unit 622 causes the display input device 143D to display an instruction to move to the reference point, and as the information 631, stores, in the storage unit 63, information on the position and the attitude of the work implement 130 and the revolution angle of the revolving body 120 acquired on the basis of the excavator coordinate system at each of the reference points, on the basis of the input operation by the operator to the display input device 143D and the information inputted by the information input-output unit 621. Note that the reference point setting unit 622 can change the setting of the reference points at any given timing. That is, for example, before the automatic revolution is performed, the reference point setting unit 622 can set once the loading revolution target point TLP (soil removal point), the returning revolution target point TRP (excavation starting point), and the interference avoiding point (EVP), and then, set these points during the operation at any given timing, for example. In this case, fine adjustment of the reference points can be adjusted on an as-necessary basis. For example, it is possible to perform fine adjustment of the load revolution target point TLP (soil removal point) or the returning revolution target point TRP (excavation starting point) or the like on an as-necessary basis.

The revolution direction setting unit 623 sets the revolution direction of the work implement 130 that is used to move to the target position. The revolution direction setting unit 623 sets, for example, the revolution direction in the loading revolution control (first revolution control) and the returning revolution control (second revolution control) on the basis of the positional relationship between the loading target and the work machine.

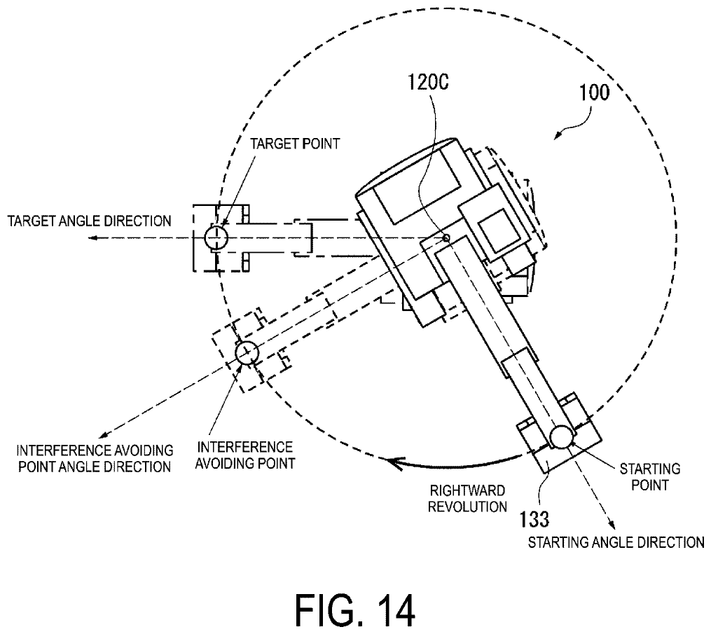

The revolution direction setting unit 623 sets the revolution direction to a direction in which the bucket 133 moves over the interference avoiding point (EVP) to the loading revolution target point TLP (first target point) corresponding to the soil removal position (unloading target position) or in which the bucket 133 moves to the returning revolution target point TRP (second target point) corresponding to the excavation starting position (loading target position). FIG. 12 illustrates an operation example of the revolution direction setting unit 623 of this case. The process shown in FIG. 12 is started when the automation starting switch is operated. When the process shown in FIG. 12 is started, the revolution direction setting unit 623 first acquires the target angle described with reference to FIGS. 6 and 7 and the like (step S101). Next, the revolution direction setting unit 623 acquires the interference avoiding point angle (step S102). Then, in a case of revolving to the left, the revolution direction setting unit 623 determines whether the revolution goes over the interference avoiding point angle and reaches the target angle (step S103). In a case where revolution to the left is performed and the revolution goes over the interference avoiding point angle and reaches the target angle (step S103: YES), the revolution direction setting unit 623 sets the revolution to the left as the revolution direction (step S104), and ends the process shown in FIG. 12. In a case where revolution to the left is performed and the revolution does not go over the interference avoiding point angle or reach the target angle (step S103: NO), the revolution direction setting unit 623 sets the revolution to the right as the revolution direction (step S105), and ends the process shown in FIG. 12. FIG. 13 illustrates an example in which setting is made to the revolution to the left. FIG. 14 illustrates an example in which setting is made to the revolution to the right. In this case, the loading revolution or the returning revolution is performed in a direction in which the interference avoiding point that has been taught exists. This makes it possible to prevent a situation where, in a case where revolution, for example, at or around 180 degrees is performed, it is unsure in which direction the revolution is performed. That is, it is possible to set the reference point to a direction in which revolution is desired, and revolve toward the reference point.

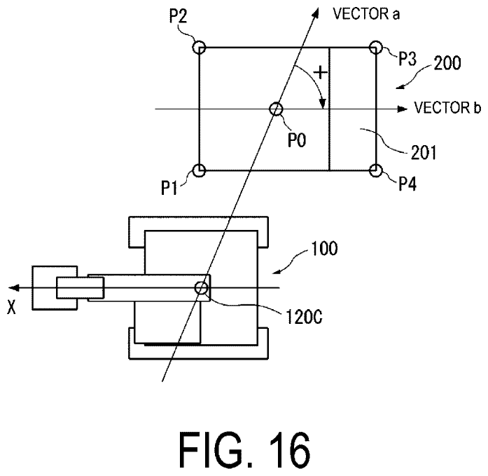

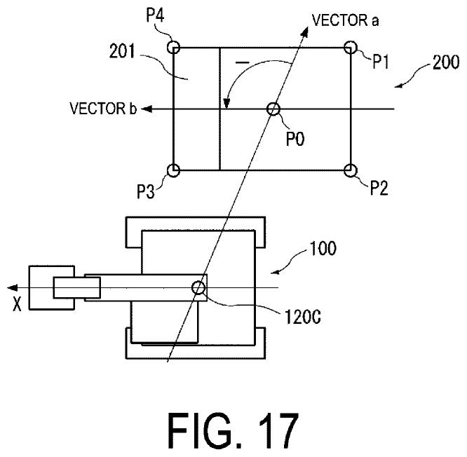

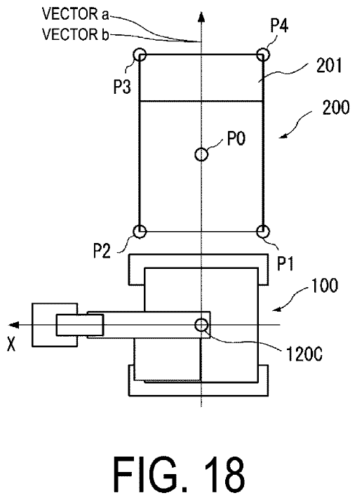

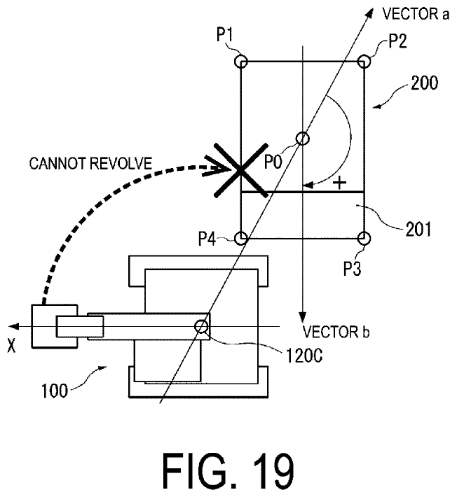

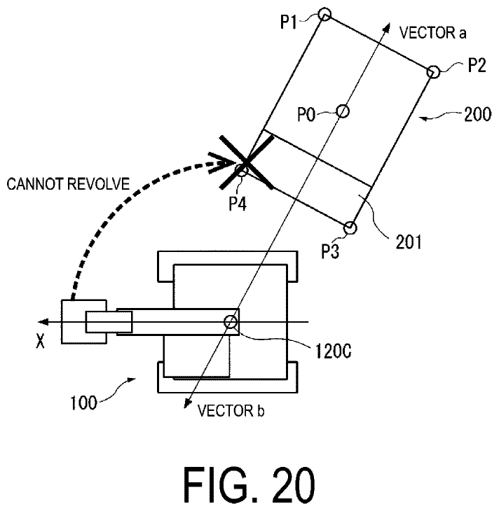

In addition, for example, in a case where the target (loading target) of unloading (loading, soil removal, or the like) is a dump truck, and the cab 201 of the dump truck 200 and the bucket 133 interfere with each other, the revolution direction setting unit 623 sets the revolution direction to a direction in which the interference with the cab 201 of the dump truck 200 does not occur, on the basis of the positional relationship between the revolution center (revolution axis 120C) and the dump truck 200. The direction in which interference does not occur means a direction in which the bucket 133 and the cab 201 of the transporting vehicle do not overlap with each other in the top view when the transporting vehicle is viewed from above. For example, when the transporting vehicle is viewed in the top view from above, the revolution direction is set to a direction in which the bucket 133 does not pass through the upper side of the cab 201. FIG. 15 illustrates an operation example of the revolution direction setting unit 623 in this case. Note that the operation example illustrated in FIG. 15 is an operation example on the assumption that the work machine 100 and the dump truck 200 serving as a loading target of the work machine 100 are substantially in a parallel state (the X direction (front-rear direction of the work machine 100) and a vector b (front-rear direction of the dump truck 200) that will be described later are substantially in parallel). Here, the “substantially in parallel” means falling within a predetermined angle range from being parallel. The process shown in FIG. 15 is started when the automation starting switch 1432 is operated. When the process shown in FIG. 15 is started, the revolution direction setting unit 623 acquires positional information on a soil removal target point PO illustrated in FIG. 16 or FIG. 17 and the positional coordinates of four points P1 to P4 that are points on the outline of the truck on the basis of the excavator coordinate system (step S201). Note that it is possible to acquire the positional coordinates of four points P1 to P4 that are points on the outline of the truck, for example, through vehicle-to-vehicle communication, or acquire them using an external sensor such as a LiDAR device, a radar scanner, or a camera provided at the work machine 100, for example. Next, the revolution direction setting unit 623 calculates a vector (vector a) connecting the original point (revolution axis 120C) of the excavator coordinate system and the soil removal point PO (step S202). Next, the revolution direction setting unit 623 calculates a vector (vector b) of an X axis of the truck coordinate system (step S203). The truck coordinate system is a coordinate system with the reference being the position and the direction of the dump truck 200. In addition, the direction of the vector b is set to the forward direction of the cab 201 of the dump truck 200. When the loading platform side is assumed to be the rearward direction, the direction of the vector b is a direction from the loading platform toward the cab 201. Next, the revolution direction setting unit 623 determines whether the angle formed by the vector a and the vector b as viewed in plan view from above is greater than 0 degrees (step S204). In a case where the angle formed by the vector a and the vector b is greater than 0 degrees, the revolution direction setting unit 623 sets the revolution to the right (step S205), and ends the process shown in FIG. 15. In a case where the angle formed by the vector a and the vector b is not greater than 0 degrees, the revolution direction setting unit 623 sets the revolution to the left (step S206), and ends the process shown in FIG. 15. In the example illustrated in FIG. 16, the angle is greater than 0, and hence, the revolution direction is set to the rightward direction. In the example illustrated in FIG. 17, the angle is not greater than 0, and hence, the revolution direction is set to the leftward direction. In this case, it is possible to get the work implement 130 closer to the loading platform 202 of the dump truck 200 from the rearward side, and hence, this is preferable, as compared with a case of passing through above the cab 201. Note that, when the angle formed by the vector a and the vector b is at or around 0 degrees and falls within a predetermined range from 0 degrees that is set in advance (see FIG. 18), it may be possible to automatically revolve in a direction at the minimum revolution angle. Furthermore, when the angle formed by the vector a and the vector b is at-180 degrees and both vectors are opposed to each other, or when the angle falls within a predetermined range that is set in advance, from-180 degrees, that is, when the dump truck 200 is opposed to the work machine 100 (see FIGS. 19 and 20), the revolution direction is not determined, the automatic revolution is not operated, and a display or sound indicating that the position or the attitude of the bucket 133 is not appropriate is outputted on the display input device 143D for a predetermined period of time, for example.

Note that the revolution direction setting unit 623 may manually perform setting on the basis of an input operation by an operator to the display input device 143D, for example. In addition, for example, in a case of the soil removal operation performed to a hopper with which no interfering object exists or to a work implement for the ground, the revolution direction setting unit 623 may set the revolution direction to a direction in which the revolution angle is the minimum. For example, if the bucket 133 and the cab 201 of the transporting vehicle do not overlap with each other in the top view when the transporting vehicle is viewed from above, it may be possible to set the revolution direction to a direction in which the revolution angle up to the target direction becomes the minimum revolution angle. In addition, as for the setting method, the operator can make selection on an as-necessary basis through a touching operation to an input operation, for example.

In a case where the automation starting switch 1432 is one operation switch and an operation is performed to the automation starting switch 1432 (predetermined operation unit), the starting instruction receiving unit 624 receives it as a starting instruction for loading revolution control (first revolution control in which the work tool is moved to the first target point corresponding to the unloading target position) or a starting instruction for returning revolution control (second revolution control in which the work tool is moved to the second target point corresponding to the target position for excavation). This configuration makes it possible to give an instruction of starting revolving using one operation switch.

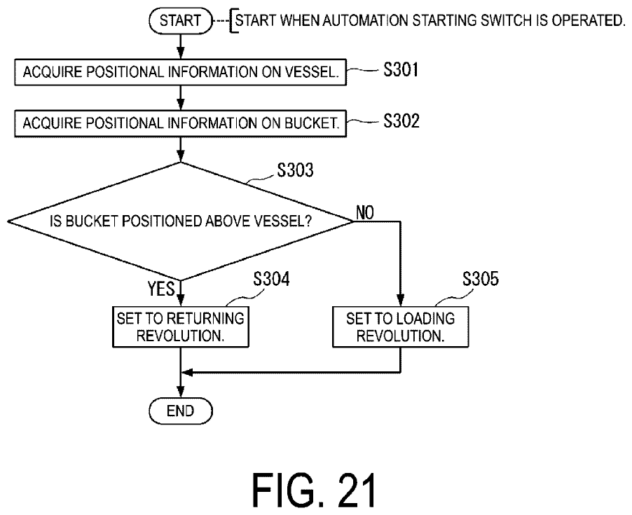

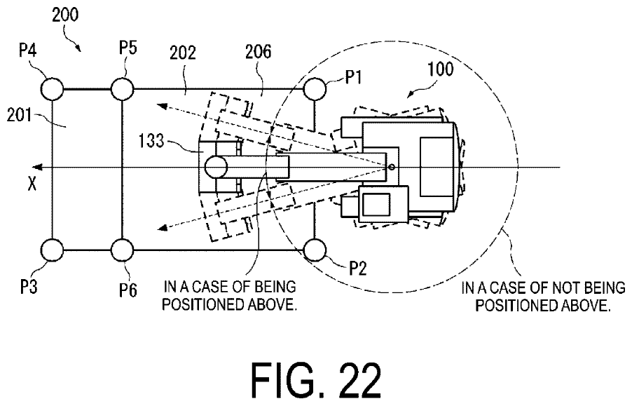

Furthermore, in a case where the automation starting switch 1432 is one operation switch, when the automation starting switch 1432 is operated and the bucket 133 is positioned above the loading platform 202 or the vessel 206 of the dump truck 200 (when the work tool is positioned within a predetermined range from the first target point) as illustrated, for example, in FIG. 22, the starting instruction receiving unit 624 receives it as a starting instruction for the returning revolution control (second revolution control). Alternatively, when the bucket 133 is not positioned above the loading platform 202 or the vessel 206 of the dump truck 200 (when the work tool is not positioned within a predetermined range from the first target point), it is received as a starting instruction for the loading revolution control (first revolution control). Note that, in FIG. 22, positions P5 and P6 are positions at end portions of the cab 201. FIG. 21 shows an operation example of the starting instruction receiving unit 624 of this case. The process shown in FIG. 21 is started when the automation starting switch 1432 is operated. When the process shown in FIG. 21 is started, the starting instruction receiving unit 624 acquires positional information on the vessel 206 (step S301). Next, the starting instruction receiving unit 624 acquires positional information on the bucket 133 (step S302). For example, the position of the bucket 133 is a position of the bucket pin 133P in the excavator coordinate system and includes a direction in which the revolving body 120 is directed. Next, the starting instruction receiving unit 624 determines whether the bucket 133 is positioned above the vessel 206 (step S303). In a case where the bucket 133 is positioned above the vessel 206 (step S303: YES), the starting instruction receiving unit 624 sets the returning revolution as a revolution mode (type of revolution control) (step S304), and ends the process shown in FIG. 21. In a case where the bucket 133 is not positioned above the vessel 206 (step S303: NO), the starting instruction receiving unit 624 sets the loading revolution as the revolution mode (step S305), and ends the process shown in FIG. 21.

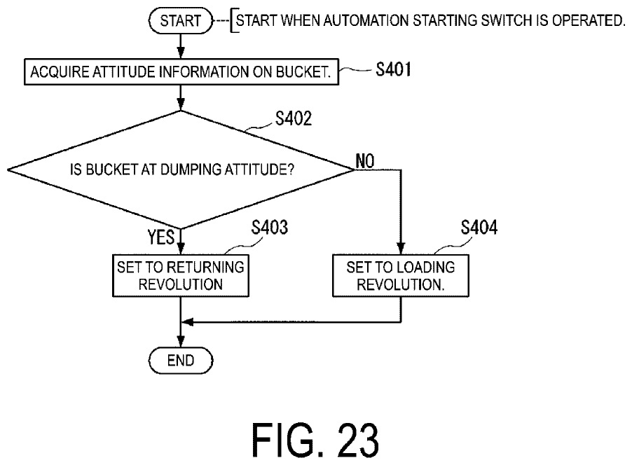

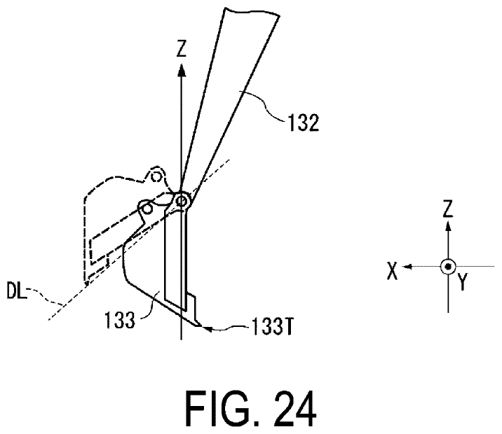

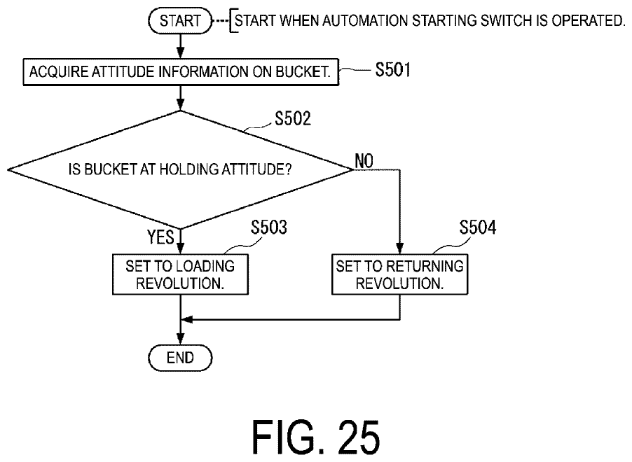

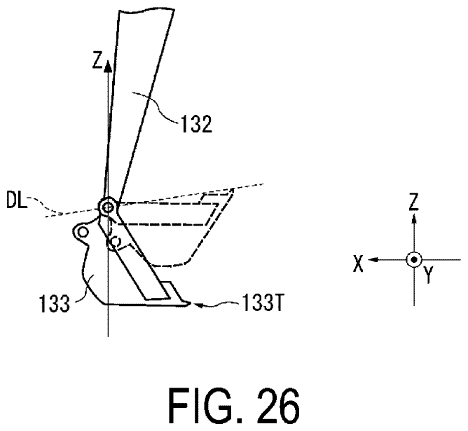

In addition, in a case where the automation starting switch 1432 is one operation switch, when the automation starting switch 1432 is operated and the bucket 133 is at a dumping attitude (when the work tool is at a predetermined unloading attitude) as illustrated, for example, in FIG. 24, the starting instruction receiving unit 624 receives it as a starting instruction for the returning revolution control (second revolution control). Alternatively, when the automation starting switch 1432 is operated and the bucket 133 is at a holding attitude (when the work tool is at a predetermined loading attitude) as illustrated in FIG. 26, it is received as a starting instruction for the loading revolution control (first revolution control). In this case, the work machine 100 alone can set the revolution mode. The operation example of this case is illustrated in FIGS. 23 and 25. The dumping attitude is an attitude in which soil removal is performed for a load in the bucket 133. The dumping attitude is an attitude (dashed line DL in FIG. 24) in which a blade edge 133T of the bucket 133 is directed in a direction further away from the work machine 100 than the attitude in which the blade edge 133T of the bucket 133 is directed in the vertical direction as illustrated, for example, in FIG. 24. In addition, the holding attitude is an attitude in which a load is loaded in the bucket 133. The holding attitude is an attitude in which the blade edge 133T of the bucket 133 is directed in a direction further approaching the work machine 100 than the attitude in which the blade edge 133T of the bucket 133 is directed in the vertical direction as illustrated, for example, by the dashed line DL in FIG. 26. It is preferable that the approaching direction should be a direction in which the blade edge 133T is directed more upward than a direction perpendicular to the vertical direction as illustrated by the dashed line DL in FIG. 24. Note that the attitude of the bucket 133 may be corrected on the basis of the pitch angle of the work machine 100.

The process shown in FIG. 23 is started when the automation starting switch 1432 is operated. When the process shown in FIG. 23 is started, the starting instruction receiving unit 624 acquires attitude information on the bucket 133 (step S401). Next, the starting instruction receiving unit 624 determines whether the bucket 133 is at the dumping attitude (step S402). In a case where the bucket 133 is in the dumping attitude (step S402: YES), the starting instruction receiving unit 624 sets the returning revolution as the revolution mode (step S403), and ends the process shown in FIG. 23. In a case where the bucket 133 is not in the dumping attitude (step S402: NO), the starting instruction receiving unit 624 sets the loading revolution as the revolution mode (step S404), and ends the process shown in FIG. 23. In addition, it may be possible to correct the attitude information on the bucket 133 specified by the starting instruction receiving unit 624 by considering slope information on the vehicle body such as the pitch angle or the roll angle of the vehicle body (traveling body 110) measured on the basis of the IMU of the vehicle body.

The process shown in FIG. 25 is started when the automation starting switch 1432 is operated. When the process shown in FIG. 25 is started, the starting instruction receiving unit 624 acquires attitude information on the bucket 133 (step S501). Next, the starting instruction receiving unit 624 determines whether the bucket 133 is at the holding attitude (step S502). In a case where the bucket 133 is at the holding attitude (step S502: YES), the starting instruction receiving unit 624 sets the loading revolution as the revolution mode (step S503), and ends the process shown in FIG. 25. In a case where the bucket 133 is not at the holding attitude (step S502: NO), the starting instruction receiving unit 624 sets the returning revolution as the revolution mode (step S504), and ends the process shown in FIG. 25.

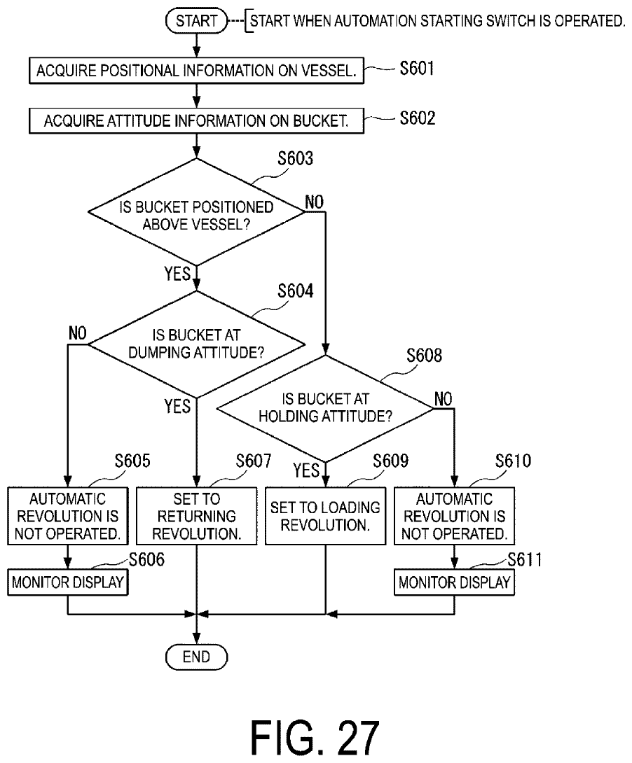

In addition, in a case where the automation starting switch 1432 is one operation switch, when the switch is operated and the bucket 133 is not at the dumping attitude (when the work tool is not at a predetermined unloading attitude), the starting instruction receiving unit 624 does not receive the operation to the switch, even when the bucket 133 is positioned above the loading platform 202 or the vessel 206 of the dump truck 200 (even when the work tool is positioned within a predetermined range from the first target point) as illustrated, for example, in FIG. 22. Alternatively, it may be possible to employ a configuration in which, when the switch is operated and the bucket 133 is not at the holding attitude (when the work tool is not at the predetermined loading attitude), the operation to the switch is not received even when the bucket 133 is not positioned above the loading platform 202 or the vessel 206 of the dump truck 200 (even when the work tool is not positioned within a predetermined range from the first target point). The operation example in this case is shown in FIG. 27.

The process shown in FIG. 27 is started when the automation starting switch 1432 is operated. When the process shown in FIG. 27 is started, the starting instruction receiving unit 624 acquires positional information on the vessel 206 (step S601), and also acquires position and attitude information on the bucket 133 (step S602). For example, the position of the bucket 133 is a position of the bucket pin 133P in the excavator coordinate system and includes a direction in which the revolving body 120 is directed. The starting instruction receiving unit 624 is able to acquire information indicating the positional relationship between the vessel 206 and the bucket 133 on the basis of the positional information on the work machine 100, the positional information on the vessel 206 acquired in step S601, and the position and attitude information on the bucket 133 acquired in step S602. Note that the position and attitude information on the bucket 133 can be calculated, for example, on the basis of the azimuth angle information on the revolving body 120 and the attitude information on the work implement 130 (the boom, the arm, and the bucket). Next, the starting instruction receiving unit 624 determines whether the bucket 133 is positioned above the vessel 206 (step S603). In a case where the bucket 133 is positioned above the vessel 206 (step S603: YES), the starting instruction receiving unit 624 determines whether the bucket 133 is at the dumping attitude (step S604). In a case where the bucket 133 is at the dumping attitude (step S604: YES), the starting instruction receiving unit 624 sets the returning revolution as the revolution mode (step S607), and ends the process shown in FIG. 27. In a case where the bucket 133 is not in the dumping attitude (step S604: NO), the starting instruction receiving unit 624 does not cause the automatic revolution to be operated (step S605), a display or sound indicating that the position or the attitude of the bucket 133 is not appropriate is outputted on the display input device 143D for a predetermined period of time, for example (step S606), and the process shown in FIG. 27 ends. Note that a step of step S601 may be provided.

In a case where the bucket 133 is not positioned above the vessel 206 (step S603: NO), the starting instruction receiving unit 624 determines whether the bucket 133 is at the holding attitude (step S608). In a case where the bucket 133 is at the holding attitude (step S608: YES), the starting instruction receiving unit 624 sets the loading revolution as the revolution mode (step S609), and ends the process shown in FIG. 27. In a case where the bucket 133 is not at the holding attitude (step S608: NO), the starting instruction receiving unit 624 does not cause the automatic revolution to be operated (step S610), a display or sound indicating that the position or the attitude of the bucket 133 is not appropriate is outputted on the display input device 143D for a predetermined period of time, for example (step S611), and the process shown in FIG. 27 ends. This configuration makes it possible to prevent the automatic revolution control from being performed in a state where the position or the attitude of the bucket 133 is not appropriate.

In addition, in a case where the automation starting switch 1432 includes two operation switches (for example, in a case where the loading revolution automation starting switch 1432 and the returning revolution automation starting switch 1433 are provided), the starting instruction receiving unit 624 may receive an operation to the loading revolution automation starting switch 1432 or the returning revolution automation starting switch 1433 (a first operation unit or a second operation unit) as a starting instruction for the loading revolution control (first revolution control) or as a starting instruction for the returning revolution control (second revolution control), provided that at least either the position or the attitude of the bucket 133 satisfies a predetermined condition (at least either the position or the attitude of the work tool satisfies a predetermined condition). In this case, for example, in a case where an operator erroneously operates the loading revolution automation starting switch 1432 and the returning revolution automation starting switch 1433, it is possible to prevent the automatic revolution control from starting.

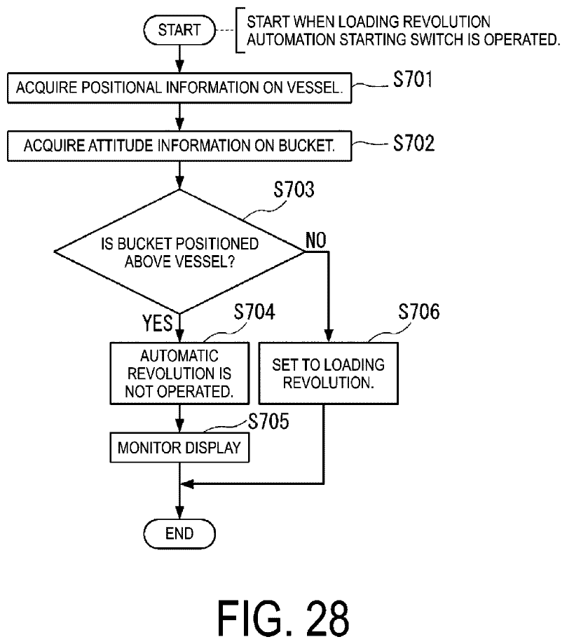

In addition, for example, in a case where the returning revolution automation starting switch 1433 (second operation unit) is operated, the starting instruction receiving unit 624 receives it as a starting instruction for the returning revolution control (second revolution control), provided that the bucket 133 is positioned above the vessel 206 (provided that the work tool is positioned within a predetermined range from the first target point). Alternatively, it may be possible to employ a configuration in which, in a case where the loading revolution automation starting switch 1432 (first operation unit) is operated, it is received as a starting instruction for the loading revolution control (first revolution control), provided that the bucket 133 is not positioned above the vessel 206 (provided that the work tool is not positioned within a predetermined range from the first target point). The operation example in this case is shown in FIG. 28.

The process shown in FIG. 28 is started when the loading revolution automation starting switch 1432 is operated. When the process shown in FIG. 28 is started, the starting instruction receiving unit 624 acquires positional information on the vessel 206 (step S701), and also acquires positional information on the bucket 133 (step S 702). For example, the position of the bucket 133 is a position of the bucket pin 133P in the excavator coordinate system and includes a direction in which the revolving body 120 is directed. Next, the starting instruction receiving unit 624 determines whether the bucket 133 is positioned above the vessel 206 (step S703). In a case where the bucket 133 is positioned above the vessel 206 (step S703: YES), the starting instruction receiving unit 624 does not cause the automatic revolution to be operated (step S704), a display or sound indicating that the position or the attitude of the bucket 133 is not appropriate is outputted on the display input device 143D for a predetermined period of time, for example (step S705), and the process shown in FIG. 28 ends. In a case where the bucket 133 is not positioned above the vessel 206 (step S703: YES), the starting instruction receiving unit 624 sets the loading revolution as the revolution mode (step S706), and ends the process shown in FIG. 28. Note that a step of step S701 may not be provided.

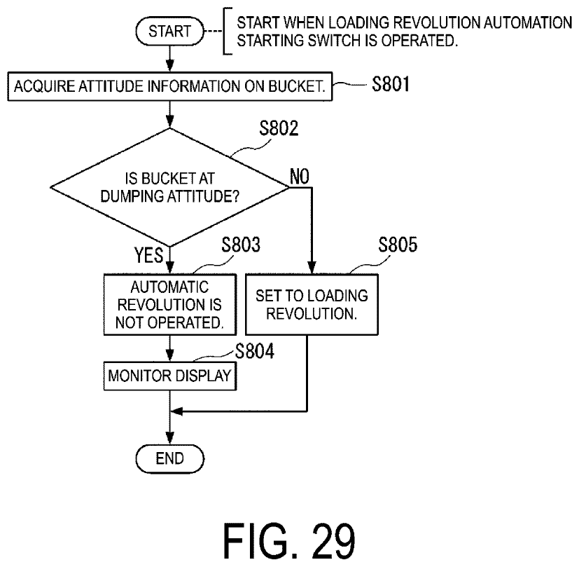

In addition, it may be possible to employ a configuration in which, for example, when a pressing operation is performed to the loading revolution automation starting switch 1432 (first operation unit), the starting instruction receiving unit 624 receives the operation to the switch as a starting instruction for the loading revolution control (first revolution control), provided that the bucket 133 is at the holding attitude (the work tool is at a predetermined loading attitude), or when a pressing operation is performed to the returning revolution automation starting switch 1433 (second operation unit), it receives the operation to the switch as a starting instruction for the returning revolution control (second revolution control), provided that the bucket 133 is at the dumping attitude (the work tool is at a predetermined unloading attitude). The operation example in this case is shown in FIG. 29.

The process shown in FIG. 29 is started when the loading revolution automation starting switch 1432 is operated. When the process shown in FIG. 29 is started, the starting instruction receiving unit 624 acquires attitude information on the bucket 133 (step S801). Next, the starting instruction receiving unit 624 determines whether the bucket 133 is at the dumping attitude (step S802). In a case where the bucket 133 is at the dumping attitude (step S802: YES), the starting instruction receiving unit 624 does not cause the automatic revolution to be operated (step S803), a display or sound indicating that the attitude of the bucket 133 is not appropriate is outputted on the display input device 143D for a predetermined period of time, for example (step S804), and the process shown in FIG. 29 ends. In a case where the bucket 133 is not at the dumping attitude (step S802: NO), the starting instruction receiving unit 624 sets the loading revolution as the revolution mode (step S805), and ends the process shown in FIG. 29.

Note that, as for the way of operating a plurality of starting instruction receiving units 624 described above, an operator can make selection on an as-necessary basis, for example.

The operation instruction switching control unit 625 controls the operation instruction switching unit 64 to output, from the operation instruction switching unit 64, either an operation instruction signal (manual) generated in response to an operation by the operator to the operation device 143 or an operation instruction signal (automatic) generated by the operation instruction signal generating unit 626. For example, in a case where the operation instruction signal generating unit 626 generates and outputs the operation instruction signal (automatic), the operation instruction switching control unit 625 selects the operation instruction signal (automatic), and outputs it from the operation instruction switching unit 64.

The operation instruction signal generating unit 626 serves as one configuration example of the control unit according to the present disclosure. The operation instruction signal generating unit 626 (control unit) generates and outputs an operation instruction signal used to perform the loading revolution control or the returning revolution control, in response to a predetermined instruction (for example, a pressing operation to the automation starting switch 1432). The operation instruction signal generating unit 626 controls movement of the bucket 133 in the loading revolution control and the returning revolution control on the basis of the reference point. The operation instruction signal generating unit 626 controls movement of the bucket 133 in the loading revolution control and the returning revolution control, for example, on the basis of the interference avoiding point.

In addition, in a case where the starting instruction receiving unit 624 receives an operation to the automation starting switch 1432 as a starting instruction for the loading revolution control, the operation instruction signal generating unit 626 performs the loading revolution control, and in a case where the starting instruction receiving unit 624 receives an operation to the automation starting switch 1432 as a starting instruction for the returning revolution control, the operation instruction signal generating unit 626 performs previous returning revolution control.

Furthermore, the operation instruction signal generating unit 626 performs the loading revolution control on the basis of the loading revolution target point TLP and the interference avoiding point EVP, and also performs the returning revolution control on the basis of an interference avoiding vertical plane VS (interference avoiding plane) including the returning revolution target point TRP and the interference avoiding point EVP. For example, when the starting instruction receiving unit 624 receives an operation to the automation starting switch 1432 as a starting instruction for the returning revolution control, the interference avoiding point EVP is calculated on the basis of the position of the bucket 133. That is, in a case of the returning revolution control, the interference avoiding point EVP calculated on the basis of the position of the bucket is a passing point that passes through the interference avoiding vertical plane VS and is included in the interference avoiding vertical plane VS. That is, the interference avoiding point EVP in a case of the returning revolution control and the interference avoiding point EVP in a case of the loading revolution control are positions that differ from each other.

In addition, in a case where the interference avoiding plane is the interference avoiding vertical plane VS that includes the revolution axis 120C passing through the revolution center and also includes the interference avoiding point EVP, the operation instruction signal generating unit 626 sets the height (predetermined height of the work tool) of the bucket pin 133P of the bucket 133 so as to be equal to or higher than the height of the interference avoiding point EVP, between a time when the returning revolution control starts and a time when the interference avoiding vertical plane VS is passed through.

Furthermore, the operation instruction signal generating unit 626 performs control of the attitude of the work implement 130 and control of revolution of the revolving body 120 in a combined manner in either the first region or the second region having a boundary at the interference avoiding plane, and performs only control of revolution of the revolving body 120 in the other region.

In addition, when the starting instruction receiving unit 624 receives an operation to the loading revolution automation starting switch 1432 as a starting instruction for the loading revolution control, the operation instruction signal generating unit 626 performs the loading revolution control. In addition, when an operation to the returning revolution automation starting switch 1433 is received as a starting instruction for the returning revolution control, the operation instruction signal generating unit 626 performs the returning revolution control. In the present embodiment, the operation instruction signal generating unit 626 performs control of moving the bucket 133 serving as the work tool to the target position. Note that the reference point setting unit 622 sets the reference point. Then, the operation instruction signal generating unit 626 performs the control on the basis of the reference point. In addition, the operation instruction signal generating unit 626 performs control on the basis of the first region and the second region having the boundary at a perpendicular plane including the reference point and the revolution axis passing through the revolution center. Furthermore, the operation instruction signal generating unit 626 performs control of the attitude of the work implement 130 and control of revolution of the revolving body 120 in a combined manner in the first region, and in the second region, performs control of revolution of the revolving body 120. In addition, the operation instruction signal generating unit 626 performs the first revolution control in which the bucket 133 is moved to the soil removal point corresponding to the unloading target position, or performs the second revolution control in which the bucket 133 is moved to the excavation starting point corresponding to the target position for loading. Here, the first region is a region extending from the excavation starting point to the perpendicular plane, and the second region is a region extending from the soil removal point to the perpendicular plane. Furthermore, the operation instruction signal generating unit 626 performs the second revolution control on the basis of the soil removal point and the perpendicular plane. In addition, in the second revolution control, in a case where the bucket 133 passes through the interference avoiding plane including a reference point used to avoid interference, the operation instruction signal generating unit 626 performs control such that the predetermined height of the bucket 133 is equal to or higher than the height of the reference point in the interference avoiding plane. Furthermore, the operation instruction signal generating unit 626 performs the first revolution control on the basis of the excavation starting point and the reference point. Note that the reference point is set so as to avoid interference between the work implement 130 and the loading target.

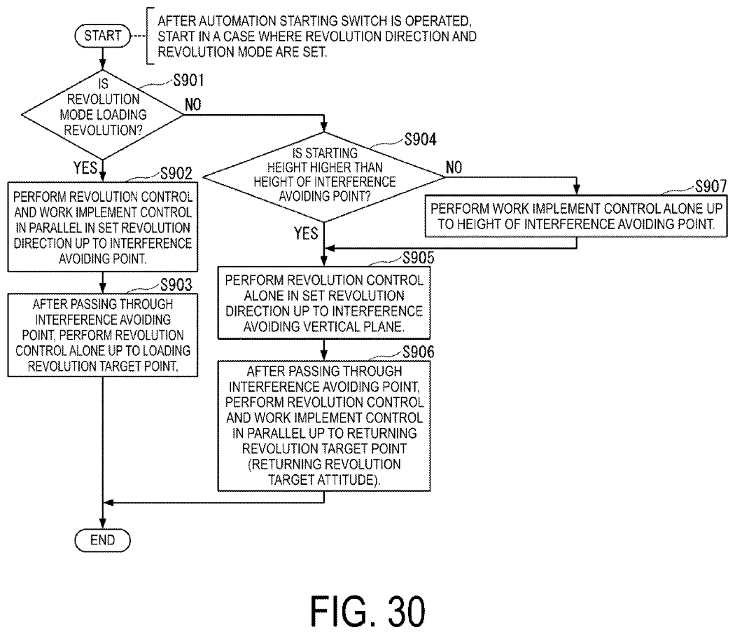

FIG. 30 shows an operation example of the operation instruction signal generating unit 626. After the automation starting switch 1432 is operated, the operation shown in FIG. 30 is started in a case where the revolution direction and the revolution mode are set. When the process shown in FIG. 30 is started, the operation instruction signal generating unit 626 determines whether the loading revolution is set as the revolution mode (step S901). In a case where the loading revolution is set as the revolution mode (step S901: YES), the operation instruction signal generating unit 626 performs the revolution control and work implement control in a combined manner in the set revolution direction up to the interference avoiding point (step S902). After passing through the interference avoiding point, the operation instruction signal generating unit 626 performs the revolution control alone up to the loading revolution target point (step S903), and ends the process shown in FIG. 30.

In a case where the loading revolution is not set as the revolution mode (step S901: NO), the operation instruction signal generating unit 626 determines whether the starting height is equal to or higher than the height of the interference avoiding point (step S904). In a case where the starting height is not equal to or higher than the height of the interference avoiding point (step S904: NO), the operation instruction signal generating unit 626 performs the work implement control alone up to the height of the interference avoiding point (step S907). After step 907 or in a case where the starting height is equal to or higher than the height of the interference avoiding point (step S904: YES), the operation instruction signal generating unit 626 performs the revolution control alone in the set revolution direction up to the interference avoiding vertical plane (VS) (step S905). After the interference avoiding point is passed through, the operation instruction signal generating unit 626 performs the revolution control and the work implement control in a combined manner up to the returning revolution target point (returning revolution target attitude) (step S906), and ends the process shown in FIG. 30.

### Operation and Effects

With the present embodiment, in the returning revolution control, it is possible to avoid interference on the basis of the interference avoiding point set to avoid interference between the loading target and the bucket 133, and also suppress a useless operation of the work implement on the basis of the interference avoiding plane including the interference avoiding point. Thus, the present embodiment makes it possible to improve usability in the automatic revolution control.

These are descriptions of the embodiment according to the present invention with reference to the drawings. However, the specific configurations are not limited to the embodiment described above, and includes design modifications and the like that do not depart from the gist of the present invention. For example, it may be possible to employ a remote operation system in which a portion of the configurations of the operation device 143 and the control device 61 is disposed at a remote site, and an operator controls the work implement 130 and the revolving body 120 through wireless communication while viewing the screen of a monitor at the remote site. Further, a part or an entirety of the program executed by the computer in the above-mentioned embodiments can be distributed via a computer-readable recording medium or a communication line.

### Supplementary Notes

The control device 61 described in the embodiment can be understood in the following manner.

(1) A control device according to a first aspect of the present disclosure provides a control device of a work machine including a revolving body configured to revolve around a revolution center, and a work implement including a work tool and attached to the revolving body, the control device including: an operation instruction signal generating unit configured to perform control of moving the work tool to a target position; and a reference point setting unit configured to set a reference point, in which the operation instruction signal generating unit performs the control on the basis of the reference point.

(2) A control device according to a second aspect of the present disclosure provides the control device according to (1), in which the operation instruction signal generating unit performs the control on the basis of a first region and a second region each having a boundary at a perpendicular plane including the reference point and a revolution axis passing through the revolution center.

(3) A control device according to a third aspect of the present disclosure provides the control device according to (1) or (2), in which control of an attitude of the work implement and control of revolution of the revolving body are performed in a combined manner in the first region, and control of revolution of the revolving body is performed in the second region.

(4) A control device according to a fourth aspect of the present disclosure provides the control device according to (1) to (3), in which the control device performs first revolution control in which the work tool is moved to a soil removal point corresponding to the target position for unloading, or performs second revolution control in which the work tool is moved to an excavation starting point corresponding to the target position for loading.

(5) A control device according to a fifth aspect of the present disclosure provides the control device according to (4) based on (3) to (2), in which the first region is a region from the excavation starting point to the perpendicular plane, and the second region is a region from the soil removal point to the perpendicular plane.

(6) A control device according to a sixth aspect of the present disclosure provides the control device according to (4), in which the operation instruction signal generating unit performs the second revolution control on the basis of the soil removal point and the perpendicular plane.

(7) A control device according to a seventh aspect of the present disclosure provides the control device according to (6), or the control device according to (4) or (6), in which, in the second revolution control, in a case where the work tool passes through an interference avoiding plane including the reference point used to avoid interference, the operation instruction signal generating unit performs control such that a predetermined height of the work tool is equal to or higher than a height of the reference point at the interference avoiding plane.

### INDUSTRIAL APPLICABILITY

The control device, the control method, and the work machine according to the present disclosure make it possible to prevent interference between a loading target and a bucket and also suppress a useless operation of a work implement.

### REFERENCE SIGNS LIST

100 Work machine
110 Traveling body
120 Revolving body
130 Work implement
133 Bucket
140 Cab
143D Display input device
60 Control system
61 Control device
622 Reference point setting unit
623 Revolution direction setting unit
624 Starting instruction receiving unit
626 Operation instruction signal generating unit (control unit)

1. A control device of a work machine including a revolving body configured to revolve around a revolution center, and a work implement including a work tool and attached to the revolving body, the control device comprising:
an operation instruction signal generating unit configured to perform control of moving the work tool to a target position; and
a reference point setting unit configured to set a reference point, wherein
the operation instruction signal generating unit performs the control on the basis of the reference point.

2. The control device according to claim 1, wherein
the operation instruction signal generating unit performs the control on the basis of a first region and a second region each having a boundary at a perpendicular plane including the reference point and a revolution axis passing through the revolution center.

3. The control device according to claim 2, wherein
as the control, the operation instruction signal generating unit performs control of an attitude of the work implement and control of revolution of the revolving body in a combined manner in the first region, and in the second region, performs control of revolution of the revolving body.

4. The control device according to claim 2, wherein
as the control, the operation instruction signal generating unit performs first revolution control in which the work tool is moved to a soil removal point corresponding to the target position for unloading, or performs second revolution control in which the work tool is moved to an excavation starting point corresponding to the target position for loading.

5. The control device according to claim 4, wherein
the first region is a region from the excavation starting point to the perpendicular plane, and
the second region is a region from the soil removal point to the perpendicular plane.

6. The control device according to claim 4, wherein
the operation instruction signal generating unit performs the second revolution control on the basis of the soil removal point and the perpendicular plane.

7. The control device according to claim 6, wherein
in the second revolution control, in a case where the work tool passes through an interference avoiding plane including the reference point used to avoid interference, the operation instruction signal generating unit performs control such that a predetermined height of the work tool is equal to or higher than a height of the reference point at the interference avoiding plane.

8. The control device according to claim 4, wherein
the operation instruction signal generating unit performs the first revolution control on the basis of the excavation starting point and the reference point.

9. The control device according to claim 2, wherein the reference point is set to avoid interference between the work implement and a loading target.

10. A control method for a work machine including a revolving body configured to revolve around a revolution center, and a work implement including a work tool and attached to the revolving body, the control method comprising:
setting a reference point; and
performing control of moving the work tool to a target position on the basis of the reference point.

11. A work machine comprising:
a revolving body configured to revolve around a revolution center;
a work implement including a work tool and attached to the revolving body; and
a control device configured to control the revolving body and the work implement, wherein
the control device includes
an operation instruction signal generating unit configured to perform control of moving the work tool to a target position, and
a reference point setting unit configured to set a reference point, and
the operation instruction signal generating unit performs the control on the basis of the reference point.

12. The control device according to claim 4, wherein the reference point is set to avoid interference between the work implement and a loading target.
